(19) United States
(12) Patent Application Publication
(10) Pub. No.: US 2019/0222326 A1
(43) Pub. Date: Jul. 18, 2019

(54) SCHEDULING FOR POWER AMPLIFIER CHARACTERIZATION

(71) Applicant: QUALCOMM Incorporated, San Diego, CA (US)

(72) Inventors: Jeremy Darren DUNWORTH, La Jolla, CA (US); Timo Ville VINTOLA, San Diego, CA (US); Nicholas Michael CARBONE, San Diego, CA (US); Seyed Aidin BASSAM, San Diego, CA (US); Vladimir APARIN, San Diego, CA (US); Udara FERNANDO, San Diego, CA (US)

(21) Appl. No.: 16/247,242

(22) Filed: Jan. 14, 2019

Related U.S. Application Data
(60) Provisional application No. 62/645,742, filed on Mar. 20, 2018.
(60) Provisional application No. 62/617,486, filed on Jan. 15, 2018.

(51) Int. Cl. H04B 17/13; H04B 1/04; H04W 72/12

(52) U.S. Cl. CPC H04B 17/13; H04W 88/02; H04W 72/1278; H04B 1/04

(57) ABSTRACT

Certain aspects of the present disclosure provide systems and methods for performing a power amplifier characterization. One example method generally includes determining, by a user equipment, if a condition associated with a power amplifier characterization is met. In certain aspects, the method includes determining, by the user equipment, a calibration gap after the condition is met. The method also includes performing, by the user equipment, the power amplifier characterization of the one or more power amplifiers of the user equipment during the calibration gap.

### CROSS-REFERENCE TO RELATED APPLICATIONS & PRIORITY CLAIMS

The present Application for Patent claims priority to U.S. Provisional Application No. 62/617,486, filed Jan. 15, 2018, and U.S. Provisional Application No. 62/645,742, filed Mar. 20, 2018, each of which is assigned to the assignee of the present application and hereby expressly incorporated by reference herein in its entirety.

### BACKGROUND

### Field of the Disclosure

Certain aspects of the present disclosure generally relate to electronic circuits and, more particularly, to methods and apparatuses for scheduling and performing power amplifier characterization for one or more power amplifiers of a wireless communication device.

### Description of Related Art

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include Long Term Evolution (LTE) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In some examples, a wireless multiple-access communication system may include a number of base stations, each simultaneously supporting communication for multiple communication devices, otherwise known as user equipment (UEs). In LTE or LTE-A network, a set of one or more base stations may define an e NodeB (eNB). In other examples (e.g., in a next generation or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., a new radio base station (NR BS), a new radio node-B (NR NB), a network node, 5G NB, gNB, etc.). A base station or DU may communicate with a set of UEs on downlink channels (e.g., for transmissions from a base station or to a UE) and uplink channels (e.g., for transmissions from a UE to a base station or distributed unit).

These multiple access technologies have been adopted in various telecommunication standards to provide a common protocol that enables different wireless devices to communicate on a municipal, national, regional, and even global level. An example of an emerging telecommunication standard is new radio (NR), for example, 5G radio access. NR is a set of enhancements to the LTE mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL) as well as support beamforming, multiple-input multiple-output (MIMO) antenna technology, and carrier aggregation.

However, as the demand for mobile broadband access continues to increase, there exists a need for further improvements in NR technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Certain aspects of the present disclosure provide a method for performing power amplifier characterization. The method generally includes determining, by a user equipment while the user equipment is using at least one of a transmit power and a modulation bandwidth for transmitting signals, if power amplifier characterization of one or more power amplifiers of the user equipment has been performed within a time period by the user equipment while transmitting signals at least one of within a threshold of the transmit power and using greater than or equal to the modulation bandwidth, determining, by the user equipment, a calibration gap when it is determined power amplifier characterization of the one or more power amplifiers of the user equipment has not been performed within the time period by the user equipment while transmitting signals at least one of within the threshold of the transmit power and using greater than or equal to the modulation bandwidth, and, performing, by the user equipment, power amplifier characterization of the one or more power amplifiers of the user equipment during the calibration gap.

Certain aspects of the present disclosure provide a method for performing power amplifier characterization. The method generally includes determining, by a user equipment, if a transmit power used by the user equipment for transmitting signal has changed by at least a threshold, determining, by the user equipment, a calibration gap when it is determined the transmit power has changed by at least the threshold, and performing, by the user equipment, power amplifier characterization of one or more power amplifiers of the user equipment during the calibration gap. Certain aspects of the present disclosure provide a method for performing power amplifier characterization. The method generally includes determining, by a user equipment, if a modulation bandwidth used by the user equipment for transmitting signal has increased, determining, by the user equipment, a calibration gap when it is determined the modulation bandwidth has increased, and performing, by the user equipment, power amplifier characterization of one or more power amplifiers of the user equipment during the calibration gap.

Certain aspects of the present disclosure provide a method for performing power amplifier characterization. The method generally includes transmitting, by a user equipment to a base station, capability information of the user equipment, the capability information indicating the user equipment is configured to perform power amplifier characterization during calibration gaps, receiving, by the user equipment, control information indicating to perform power amplifier characterization, and performing, by the user equipment, the power amplifier characterization of one or more power amplifiers of the user equipment during the calibration gap.

Certain aspects of the present disclosure provide a method for performing power amplifier characterization. The method generally includes transmitting, by a user equipment to a base station, a request to perform a power amplifier characterization, receiving, by the user equipment, control information indicating to perform power amplifier characterization, and performing, by the user equipment, the power amplifier characterization of one or more power amplifiers of the user equipment during the calibration gap.

Certain aspects of the present disclosure provide a method for performing power amplifier characterization. The method generally includes receiving capability information of a user equipment, the capability information indicating the user equipment is configured to perform power amplifier characterization during calibration gaps, scheduling a calibration gap for the user equipment, and transmitting control information indicating to perform power amplifier characterization.

Certain aspects of the present disclosure provide an apparatus for performing power amplifier characterization. The apparatus generally includes a power amplifier, associated with one or more transmit chains of a first antenna layer, coupled to one or more receive chains of a second antenna layer, and a processor configured to determine if a condition associated with a power amplifier characterization is met, determine a calibration gap when the condition is met, and obtain information associated with the power amplifier characterization of the amplifiers during the calibration gap.

Certain aspects of the present disclosure provide an apparatus for performing power amplifier characterization. The apparatus generally includes means for amplifying a radio-frequency (RF) signal, associated with one or more transmit chains of a first antenna layer, coupled to one or more receive chains of a second antenna layer, and means for processing, configured to determine if a condition associated with a power amplifier characterization is met, determine a calibration gap when the condition is met, and obtain information associated with the power amplifier characterization of the amplifiers during the calibration gap.

Numerous other aspects are provided including methods, apparatus, systems, computer program products, and processing systems.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point (AP) and example user terminals, in accordance with certain aspects of the present disclosure.

FIG. 3 is a block diagram of an example transceiver front end, in accordance with certain aspects of the present disclosure.

FIG. 4 illustrates a block diagram of an example MIMO transceiver front end, in accordance with certain aspects of the present disclosure.

FIG. 5 illustrates an example timing diagram for scheduling a calibration gap, in accordance with certain aspects of the present disclosure.

FIG. 6 is a flow diagram illustrating example operations for performing power amplifier characterization, in accordance with certain aspects of the present disclosure.

FIG. 7 is a flow diagram illustrating example operations for performing power amplifier characterization based on a time period, in accordance with certain aspects of the present disclosure.

FIG. 8 is a flow diagram illustrating example operations for performing power amplifier characterization based on a transmit power threshold, in accordance with certain aspects of the present disclosure.

FIG. 9 is a flow diagram illustrating example operations for performing power amplifier characterization based on a modulation bandwidth, in accordance with certain aspects of the present disclosure.

FIG. 10 is a flow diagram illustrating example operations for performing power amplifier characterization based on messaging, in accordance with certain aspects of the present disclosure.

FIG. 11 is a flow diagram illustrating example operations for scheduling power amplifier characterization by a base station, in accordance with certain aspects of the present disclosure.

FIG. 12 is a graph of example error vector magnitudes (EVMs) with various digital predistortion (DPD) implementations, in accordance with certain aspects of the present disclosure.

FIG. 13 is a graph of example adjacent channel ratios (ACLRs) with various DPD implementations, in accordance with certain aspects of the present disclosure.

FIG. 14 is a diagram illustrating a base station in communication with a user equipment via beamforming, in accordance with certain aspects of the present disclosure.

FIG. 15 is a diagram illustrating RF exposure in different communication systems, in accordance with certain aspects of the present disclosure.

FIG. 16 illustrates an example timing diagram of power amplifier calibration gap, in accordance with certain aspects of the present disclosure.

FIG. 17 illustrates an example of exposure measurement, in accordance with certain aspects of the present disclosure.

FIG. 18 illustrates an example of in band exposure measurement, in accordance with certain aspects of the present disclosure.

FIG. 19 is a flow diagram illustrating example operations for measuring RF exposure, in accordance with certain aspects of the present disclosure.

FIG. 20 is a conceptual data flow diagram illustrating the data flow between different means/components in an exemplary apparatus, in accordance with certain aspects of the present disclosure.

FIG. 21 is a diagram illustrating an example of a hardware implementation for an apparatus employing a processing system, in accordance with certain aspects of the present disclosure.

FIG. 22 is a flow diagram illustrating example operations for configuring resources in which a user equipment may perform an RF exposure measurement, in accordance with certain aspects of the present disclosure.

FIG. 23 is a conceptual data flow diagram illustrating the data flow between different means/components in an exemplary apparatus, in accordance with certain aspects of the present disclosure.

FIG. 24 is a diagram illustrating an example of a hardware implementation for an apparatus employing a processing system, in accordance with certain aspects of the present disclosure.

FIG. 25 is a flow diagram illustrating example operations for performing a measurement during a calibration gap period, in accordance with certain aspects of the present disclosure.

FIG. 26 is a flow diagram illustrating example operations for scheduling a calibration gap period for a measurement, in accordance with certain aspects of the present disclosure.

FIG. 27 illustrates a block diagram of an example wireless communications device, in accordance with aspects of the present disclosure.

### DETAILED DESCRIPTION

Aspects of the present disclosure provide apparatus, methods, processing systems, and computer readable mediums for scheduling and performing power amplifier characterization for one or more power amplifiers of a wireless communication device. In certain aspects, the wireless communication device may use high carrier frequencies (e.g., millimeter wave (mmWave)) for communication. In aspects, the techniques may be used in multi-slice networks, such as NR (new radio access technology or 5G technology).

NR may support various wireless communication services, such as Enhanced mobile broadband (eMBB) targeting wide bandwidth (e.g. 80 MHz beyond), millimeter wave (mmWave) targeting high carrier frequency (e.g. 24.25 GHz to 71 GHz or beyond), massive MTC (mMTC) targeting non-backward compatible MTC techniques, and/or mission critical targeting ultra reliable low latency communications (URLLC). These services may include latency and reliability requirements. These services may also have different transmission time intervals (TTI) to meet respective quality of service (QoS) requirements. In addition, these services may co-exist in the same subframe.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as universal terrestrial radio access (UTRA), cdma2000, etc. UTRA includes wideband CDMA (WCDMA), time division synchronous CDMA (TD-SCDMA), and other variants of CDMA. cdma2000 covers IS-2000, IS-95 and IS-856 standards. A TDMA network may implement a radio technology such as global system for mobile communications (GSM). An OFDMA network may implement a radio technology such as evolved UTRA (E-UTRA), ultra mobile broadband (UMB), IEEE 802.11 (Wi-Fi), IEEE 802.16 (WiMAX), IEEE 802.20, Flash-OFDM®, etc. UTRA and E-UTRA are part of universal mobile telecommunication system (UMTS). 3GPP Long Term Evolution (LTE) and LTE-Advanced (LTE-A), in both frequency division duplex (FDD) and time division duplex (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies, such as a 5G nextgen/NR network.

### Example Wireless System

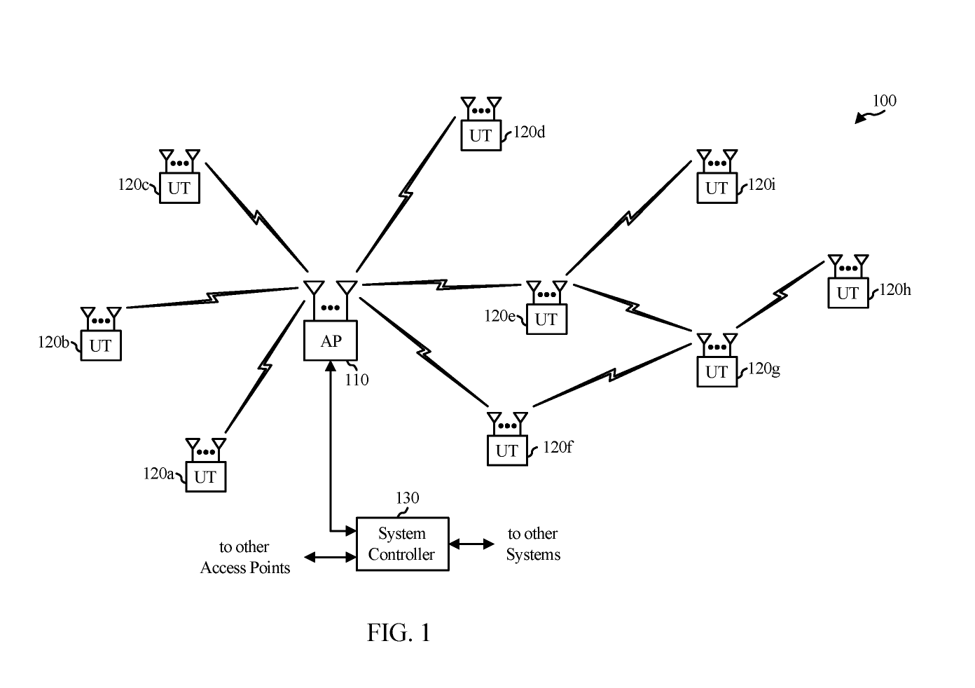

FIG. 1 illustrates a wireless communications system 100 with access points 110 and user terminals 120, in which aspects of the present disclosure may be practiced. For simplicity, only one access point 110 is shown in FIG. 1. An access point (AP) is generally a fixed station that communicates with the user terminals and may also be referred to as a base station (BS), an evolved Node B (eNB), or some other terminology. A user terminal (UT) may be fixed or mobile and may also be referred to as a mobile station (MS), an access terminal, user equipment (UE), a station (STA), a client, a wireless device, or some other terminology. A user terminal may be a wireless device, such as a cellular phone, a personal digital assistant (PDA), a handheld device, a wireless modem, a laptop computer, a tablet, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

Wireless communications system 100 employs multiple transmit and multiple receive antennas for data transmission on the downlink and uplink. Access point 110 may be equipped with a number Nₐₚ of antennas to achieve transmit diversity for downlink transmissions and/or receive diversity for uplink transmissions. A set Nᵤ of selected user terminals 120 may receive downlink transmissions and transmit uplink transmissions. Each selected user terminal transmits user-specific data to and/or receives user-specific data from the access point. In general, each selected user terminal may be equipped with one or multiple antennas (i.e., Nᵤₜ≥1). The Nᵤ selected user terminals can have the same or different number of antennas.

Wireless communications system 100 may be a time division duplex (TDD) system or a frequency division duplex (FDD) system. For a TDD system, the downlink and uplink share the same frequency band. For an FDD system, the downlink and uplink use different frequency bands. Wireless communications system 100 may also utilize a single carrier or multiple carriers for transmission. Each user terminal 120 may be equipped with a single antenna (e.g., to keep costs down) or multiple antennas (e.g., where the additional cost can be supported). In certain aspects of the present disclosure, the access point 110 and/or user terminal 120 may include at least one transmit chain, the power amplifier characterization of which may be scheduled as described in more detail herein.

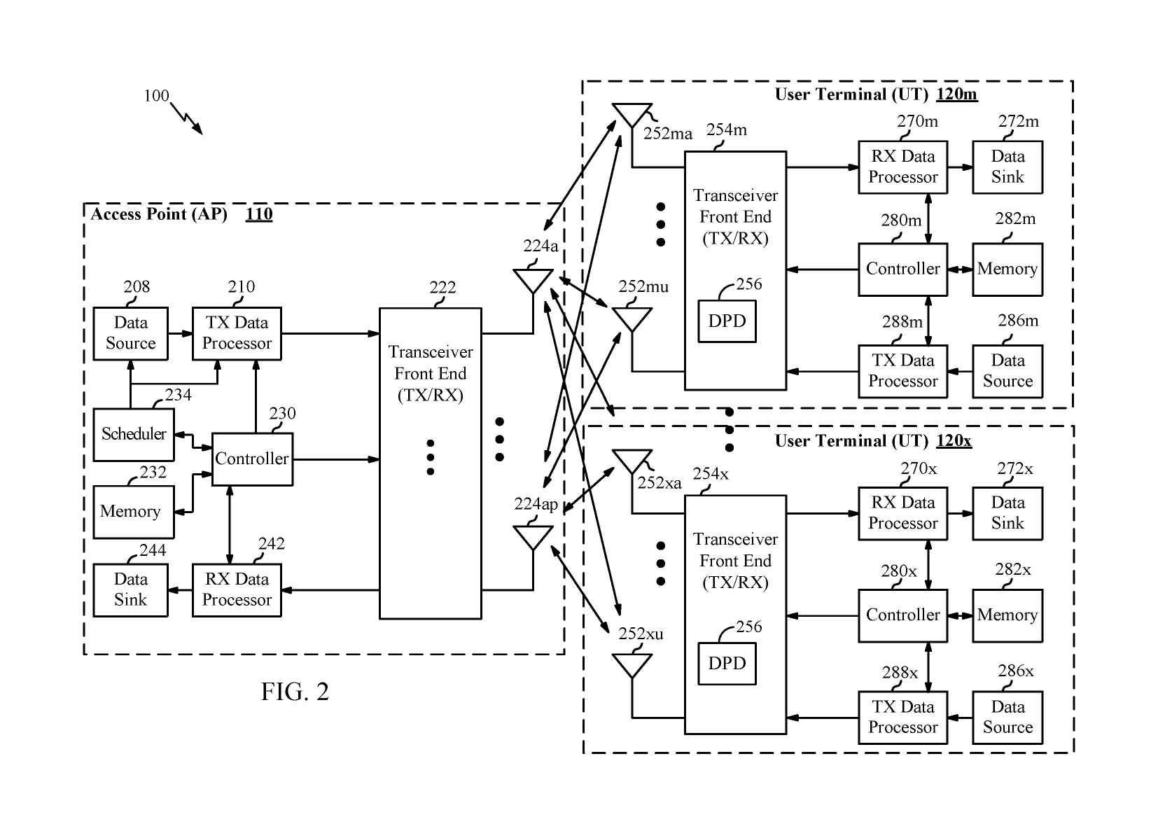

FIG. 2 shows a block diagram of access point 110 and two user terminals 120m and 120x in the wireless communications system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. Beam-steering or some other spatial processing technique may be used at the access point and user terminal.

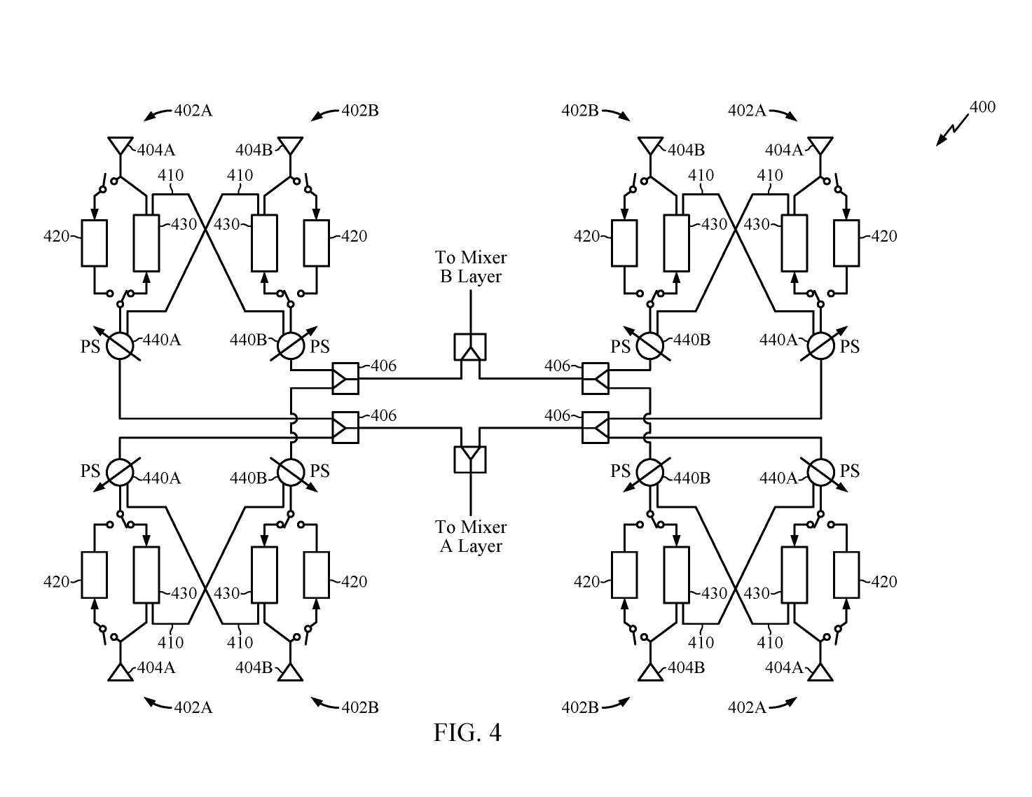

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {dᵤₚ} for the user terminal based on the coding and modulation schemes associated with the rate selected for the user terminal and provides a data symbol stream {sᵤₚ} for one of the N_{ut,m} antennas. A transceiver front end (TX/RX) 254 (also known as a radio frequency front end (RFFE)) receives and processes (e.g., converts to analog, amplifies, filters, and frequency upconverts) a respective symbol stream to generate an uplink signal. The transceiver front end 254 may also route the uplink signal to one of the N_{ut,m} antennas for transmit diversity via an RF switch, for example. The controller 280 may control the routing within the transceiver front end 254. Memory 282 may store data and program codes for the user terminal 120 and may interface with the controller 280. The transceiver front end 254 may also include a digital predistortion module 256, which performs digital predistortion (DPD) to compensate for non-linear effects of the transceiver front end 254 as further described herein with respect to FIGS. 4-12. DPD module 256 may be located within transceiver front end 254 or within TX data processor 288.

A number Nᵤₚ of user terminals 120 may be scheduled for simultaneous transmission on the uplink. Each of these user terminals transmits its set of processed symbol streams on the uplink to the access point.

At access point 110, Nₐₚ antennas 224a through 224ap receive the uplink signals from all Nᵤₚ user terminals transmitting on the uplink. For receive diversity, a transceiver front end 222 may select signals received from one of the antennas 224 for processing. The signals received from multiple antennas 224 may be combined for enhanced receive diversity. The access point's transceiver front end 222 also performs processing complementary to that performed by the user terminal's transceiver front end 254 and provides a recovered uplink data symbol stream. The recovered uplink data symbol stream is an estimate of a data symbol stream {sᵤₚ} transmitted by a user terminal. An RX data processor 242 processes (e.g., demodulates, deinterleaves, and decodes) the recovered uplink data symbol stream in accordance with the rate used for that stream to obtain decoded data. The decoded data for each user terminal may be provided to a data sink 244 for storage and/or a controller 230 for further processing. The transceiver front end (TX/RX) 222 of access point 110 and/or transceiver front end 254 of user terminal 120 may include at least one transmit chain, the EVM and/or ACLR of which may be improved as described in more detail herein.

On the downlink, at access point 110, a TX data processor 210 receives traffic data from a data source 208 for N_{dn} user terminals scheduled for downlink transmission, control data from a controller 230 and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 may provide a downlink data symbol streams for one of more of the N_{dn} user terminals to be transmitted from one of the Nₐₚ antennas. The transceiver front end 222 receives and processes (e.g., converts to analog, amplifies, filters, and frequency upconverts) the symbol stream to generate a downlink signal. The transceiver front end 222 may also route the downlink signal to one or more of the Nₐₚ antennas 224 for transmit diversity via an RF switch, for example. The controller 230 may control the routing within the transceiver front end 222. Memory 232 may store data and program codes for the access point 110 and may interface with the controller 230.

At each user terminal 120, N_{ut,m} antennas 252 receive the downlink signals from access point 110. For receive diversity at the user terminal 120, the transceiver front end 254 may select signals received from one of the antennas 252 for processing. The signals received from multiple antennas 252 may be combined for enhanced receive diversity. The user terminal's transceiver front end 254 also performs processing complementary to that performed by the access point's transceiver front end 222 and provides a recovered downlink data symbol stream. An RX data processor 270 processes (e.g., demodulates, deinterleaves, and decodes) the recovered downlink data symbol stream to obtain decoded data for the user terminal.

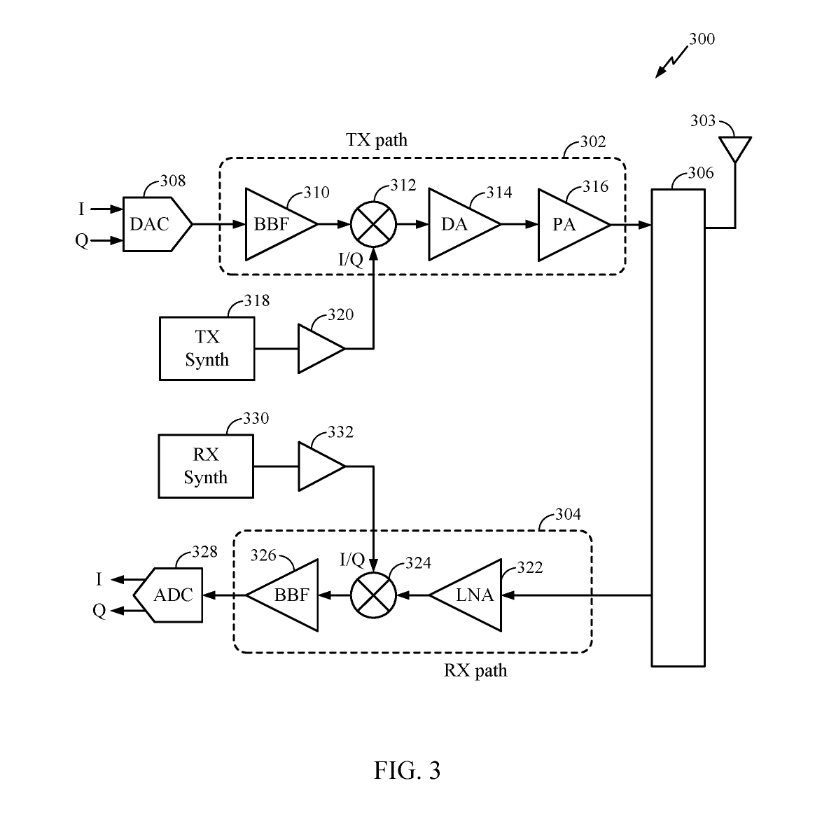

FIG. 3 is a block diagram of an example transceiver front end 300, such as transceiver front ends 222, 254 in FIG. 2, in which aspects of the present disclosure may be practiced. The transceiver front end 300 includes a transmit (TX) path 302 (also known as a transmit chain) for transmitting signals via one or more antennas and a receive (RX) path 304 (also known as a receive chain) for receiving signals via the antennas. When the TX path 302 and the RX path 304 share an antenna 303, the paths may be connected with the antenna via an interface 306, which may include any of various suitable RF devices, such as a duplexer, a switch, a diplexer, and the like.

Receiving in-phase (I) or quadrature (Q) baseband analog signals from a digital-to-analog converter (DAC) 308, the TX path 302 may include a baseband filter (BBF) 310, a mixer 312, a driver amplifier (DA) 314, and a power amplifier (PA) 316. The BBF 310, the mixer 312, and the DA 314 may be included in a radio frequency integrated circuit (RFIC), while the PA 316 may be external to the RFIC. The BBF 310 filters the baseband signals received from the DAC 308, and the mixer 312 mixes the filtered baseband signals with a transmit local oscillator (LO) signal to convert the baseband signal of interest to a different frequency (e.g., upconvert from baseband to RF). This frequency conversion process produces the sum and difference frequencies of the LO frequency and the frequency of the signal of interest. The sum and difference frequencies are referred to as the beat frequencies. The beat frequencies are typically in the RF range, such that the signals output by the mixer 312 are typically RF signals, which may be amplified by the DA 314 and/or by the PA 316 before transmission by the antenna 303. In the mmWave frequencies, the PA may be replaced by an array of power amplifiers to create a phased array transceiver to perform transmit beamforming.

The RX path 304 includes a low noise amplifier (LNA) 322, a mixer 324, and a baseband filter (BBF) 326. The LNA 322, the mixer 324, and the BBF 326 may be included in a radio frequency integrated circuit (RFIC), which may or may not be the same RFIC that includes the TX path components. RF signals received via the antenna 303 may be amplified by the LNA 322, and the mixer 324 mixes the amplified RF signals with a receive local oscillator (LO) signal to convert the RF signal of interest to a different baseband frequency (i.e., downconvert). The baseband signals output by the mixer 324 may be filtered by the BBF 326 before being converted by an analog-to-digital converter (ADC) 328 to digital I or Q signals for digital signal processing. In the mmWave frequencies, the LNA may be replaced by an array of low noise amplifiers to create a phased array transceiver to perform receive beamforming. In certain aspects of the present disclosure, the EVM and/or ACLR of the transmit chain which includes the PA 316 may be improved as described in more detail herein.

While it is desirable for the output of an LO to remain stable in frequency, tuning the LO to different frequencies typically entails using a variable-frequency oscillator, which involves compromises between stability and tunability. Contemporary systems may employ frequency synthesizers with a voltage-controlled oscillator (VCO) to generate a stable, tunable LO with a particular tuning range. Thus, the transmit LO frequency may be produced by a TX frequency synthesizer 318, which may be buffered or amplified by amplifier 320 before being mixed with the baseband signals in the mixer 312. Similarly, the receive LO frequency may be produced by an RX frequency synthesizer 330, which may be buffered or amplified by amplifier 332 before being mixed with the RF signals in the mixer 324.

### Example Scheduling for Power Amplifier Characterization

In certain aspects, a wireless device such as AP 110 (also referred to herein as BS 110) and/or UT 120 (also referred to herein as UE 120) may include a transceiver that includes dual antenna layers (e.g., support dual layer polarization MIMO) (e.g., where the device includes a 3GPP compliant mmWave transceiver) where a receiver from one layer of the transceiver can be used to feedback the transmit signal from a transmitter of another layer of the transceiver. For example, a wireless device may include a transceiver including a phased array that includes a PA that operates far away from compression in order to improve the error vector magnitude (EVM) and adjacent channel ratio (ACLR), even when not implementing DPD. However, such operation of the PA far from compression may be inefficient and lead to considerable power consumption, which may be especially undesirable for UEs 120 that run on battery as it may shorten operating time of the device. DPD can be used to significantly improve PA linearity in the form of EVM and power added efficiency (PAE), such as for PAs of phased array transceivers. In order to perform DPD, the PA gain, compression, distortion and memory of a PA need to be characterized, such as in the form of a Volterra series. As used herein, this characterization of the PA may be referred to as power amplifier characterization (PA characterization). Performing the PA characterization offline (e.g., once, after manufacturing the transmit chain of the wireless device) is expensive in terms of test time because of the variety of conditions over which the PA may need to be characterized, including output power level, modulation bandwidth, temperature, power supply variation, and phased array scan angle.

In order to more efficiently obtain the power amplifier characterization, the UE 120 may be operated according to aspects presented in this disclosure to perform the power amplifier characterization online (e.g., while the UE 120 is operating in a wireless communications environment). This enables the UE 120 to implement DPD using a robust, adaptable power amplifier characterization. For instance, the UE 120 may encounter various operating conditions, including but not limited to various output power levels, modulation bandwidths, temperatures, power supply variations, and phased array scan angles, over the course of its operating life. The UE 120 may perform the power amplifier characterization as the operating conditions change over the course of its lifetime, and this enables the DPD to take into account these operating conditions, which improves the PA linearity. The power amplifier characterization may also be used to sense the proximity of human tissue or any other material to the UE 120.

FIG. 4 illustrates a block diagram of an example MIMO phased array transceiver front-end circuit 400, in which aspects of the present disclosure may be practiced. It should be noted that aspects of the present disclosure may be practiced in other suitable transceiver front-end circuits (e.g., with multiple layers). The transceiver front-end circuit 400 is employed to perform power amplifier characterization of one or more power amplifiers as further described herein. The transceiver front-end circuit 400 may include two or more antenna layers 402A and 402B, which may implement dual layer polarization MIMO (e.g., according to 3GPP standards). For instance, antenna layer 402A may include multiple antennas 404A coupled to a mixer (not shown), such as mixer 312 of FIG. 3, via electrical couplers 406 (which may include duplexers, switches, diplexers). The antennas 404A, B are operated simultaneously or independently to provide support for beamforming, spatial diversity, phased array, MIMO, etc. In certain aspects, when supporting beamforming, phase shifters 440A, B are used to control the relative phase applied to antennas 404A,B thus controlling the phased array scan angle. Antenna layer 402B operates antennas 404B similarly.

Each antenna layer 402A, B is coupled to a receive chain 420 and a transmit chain 430 as described herein with respect to FIG. 3 (e.g., transmit chain 302 and receive chain 304). Each transmit chain 430 may include some or all of the components of the transmit chain 302 depicted in FIG. 3. For example, the transmit chain 430 may include at least one of the DAC 308, BBF 310, mixer 312, or DA 314 illustrated in FIG. 3. Likewise, each receive chain 420 may include some or all of the components of the receive chain 304 illustrated in FIG. 3. For example, the receive chain 420 include at least one of the ADC 328, BBF 326, and mixer 324 depicted in FIG. 3. Each transmit chain 430 may include a power amplifier such as PA 316 of FIG. 3. Each receive chain 420 may include a lower noise amplifier such as the LNA 322 of FIG. 3. The power amplifier characterization may be implemented by feeding the output of a transmit chain of one antenna layer into the receive chain of another antenna layer. That is, a closed feedback loop may be formed between the transmit chain and the receive chain of different antenna layers to provide a power amplifier characterization of the transmit chain. The transmit chain may amplify a modulated signal and feed that amplified, modulated signal to the receive chain. This enables the transceiver front-end circuit 400 to perform power amplifier characterization while the wireless devices is online as previously described herein.

As shown, an interface 410 may couple the output of each transmit chain 430 of one antenna layer 402A or 402B to the receive chain 420 of the other of antenna layer 402A or 402B. The interface 410 may be a wired interface or a wireless interface to provide the electrical coupling between the transmit chain 430 and receive chain 420. In one aspect of the disclosure, the output of the power amplifier (e.g., PA 316) of the transmit chain 430 may be coupled to the receive chain 420. The interface 410 may also be directionally coupled to the receive chain 420 and transmit chain 430 to only permit the feedback in one direction of signal flow. For instance, the interface 410 may include one or more directional couplers. The interface 410 may also include networks, filters, duplexers, switches, diplexers, to control when the feedback is provided to the receive chain 420.

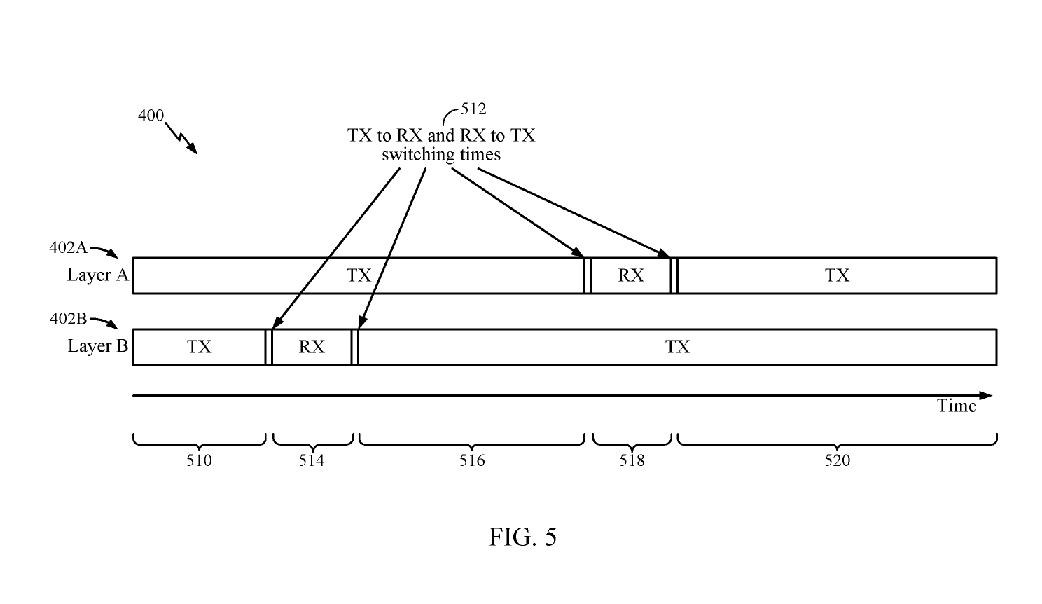

To perform the power amplifier characterization, at least one antenna of the transceiver front-end circuit 400 must operate in receive mode. Accordingly, in certain aspects of this disclosure, one or more antennas of an antenna layer (e.g., antenna layer 402A) may operate in receive mode to receive the output of one or more transmit chains of another antenna layer (e.g., antenna layer 402B). A gap in simultaneous uplink transmission of the antenna layers can be scheduled for the wireless device to perform the power amplifier characterization. This gap may be referred to as a calibration gap, which provides the period of time for an antenna layer to switch from transmit mode to receive mode, perform the power amplifier characterization, and switch the antenna layer back to transmit mode. For example, FIG. 5 illustrates an example timing diagram of calibration gaps scheduled for each antenna layer 402A, B of the front-end transceiver circuit 400, in accordance with one or more embodiments of the present disclosure.

As shown in FIG. 5, during period 510, the antenna layers 402A, B are simultaneously operating in transmit mode. As a calibration gap is scheduled, the antenna layer 402B switches to receive mode at switching period 512 and performs the power amplifier characterization at period 514. The receive chain of antenna layer 402B samples the output of the transmit chain of antenna layer 402A during period 514. Then, the antenna layer 402B switches back to transmit mode at the next switching period 512, and simultaneous uplink transmissions occurs during period 516. To provide a power amplifier characterization of the transmit chain of antenna layer 402B, another calibration gap is scheduled. Antenna layer 402A switches to receive mode at the first switching period 512 shown for this antenna layer. The power amplifier characterization of the transmit chain of antenna layer 402B is taken during period 518. Then, the antenna layer 402A switches back to transmit mode at the last switching period 512. FIG. 5 demonstrates that the calibration gap includes the time it takes for an antenna layer to switch from transmit mode to receive mode, perform the power amplifier characterization (e.g., sample the output of the transmit chain of the other antenna layer), and switch the antenna layer back to transmit mode.

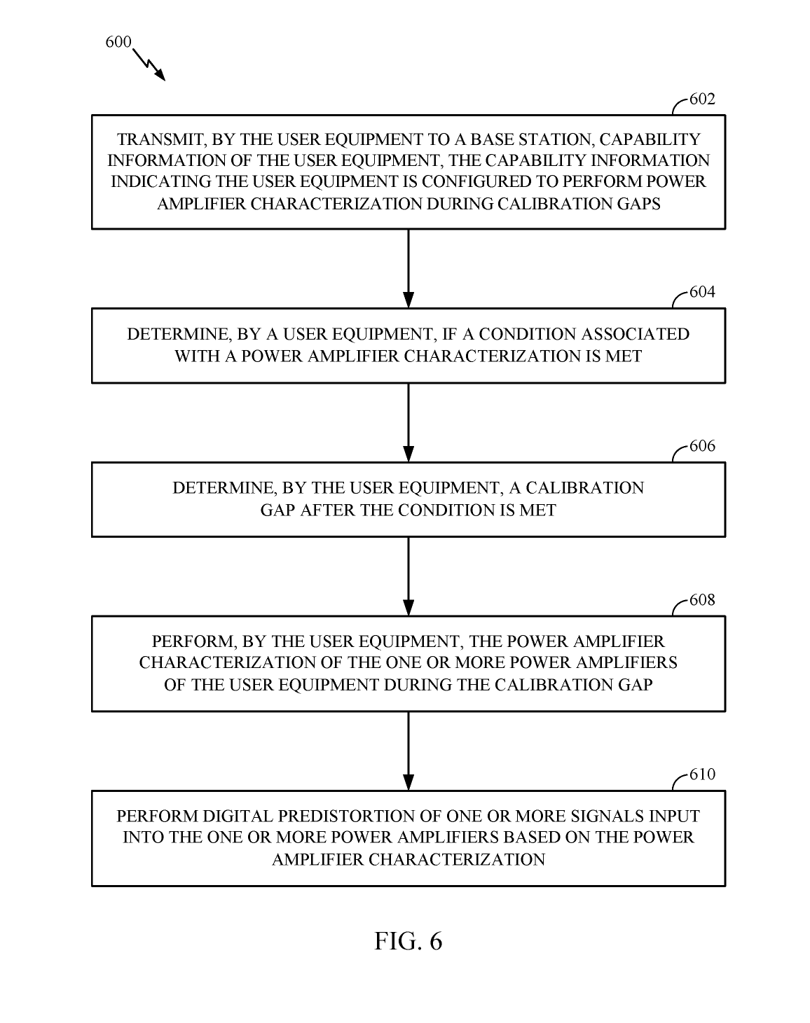

Various approaches for scheduling the calibration gap and performing a power amplifier characterization may be taken as further described herein. For example, FIG. 6 illustrates example operations 600 for performing power amplifier characterization. Operations 600 may be performed by a wireless communications device, such as user equipment (e.g., UE 120 of FIG. 1).

Operations 600 begin at 602 by transmitting, by the UE to a base station (BS), capability information of the UE (e.g., static capability information), the capability information indicating the UE is configured to perform power amplifier characterization during calibration gaps. For example, not all UEs may be configured to perform power amplifier characterization during calibration gaps as they may utilize different transceiver designs. Accordingly, the UE notifies the BS so that the BS knows whether calibration gaps need to be scheduled or not for the UE. Scheduling of calibration gaps for UEs that do not perform power amplifier characterization can adversely affect the transmit throughput of the UE due to one antenna layer not being available for transmission during a calibration gap. In certain aspects, the UE does not transmit such capability information indicating the UE is configured to perform power amplifier characterization during calibration gaps.

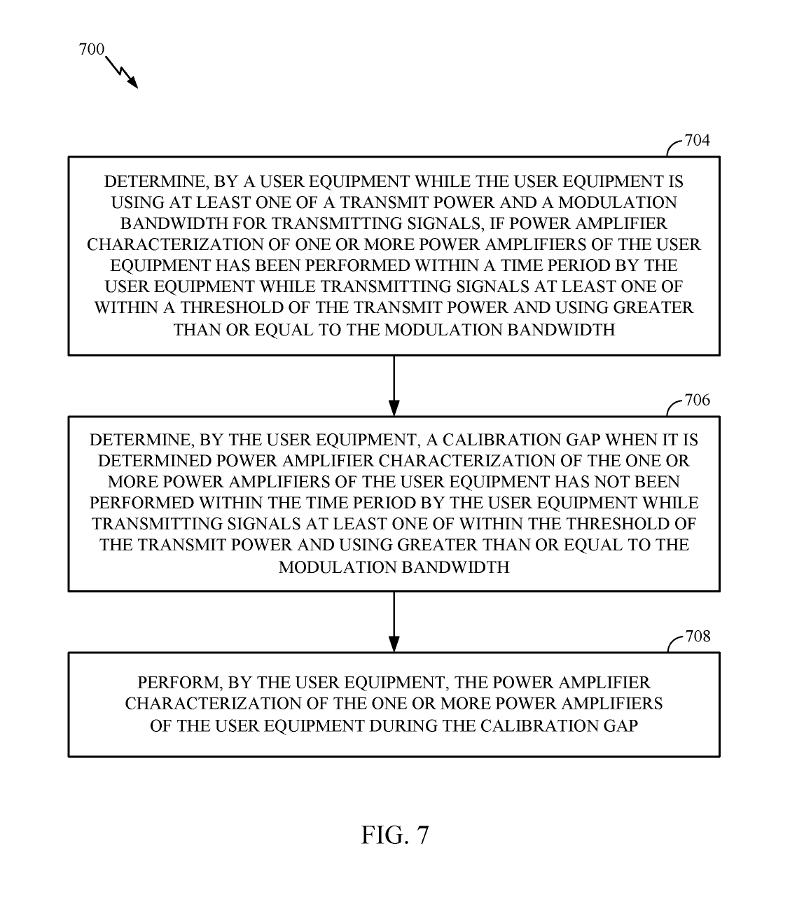

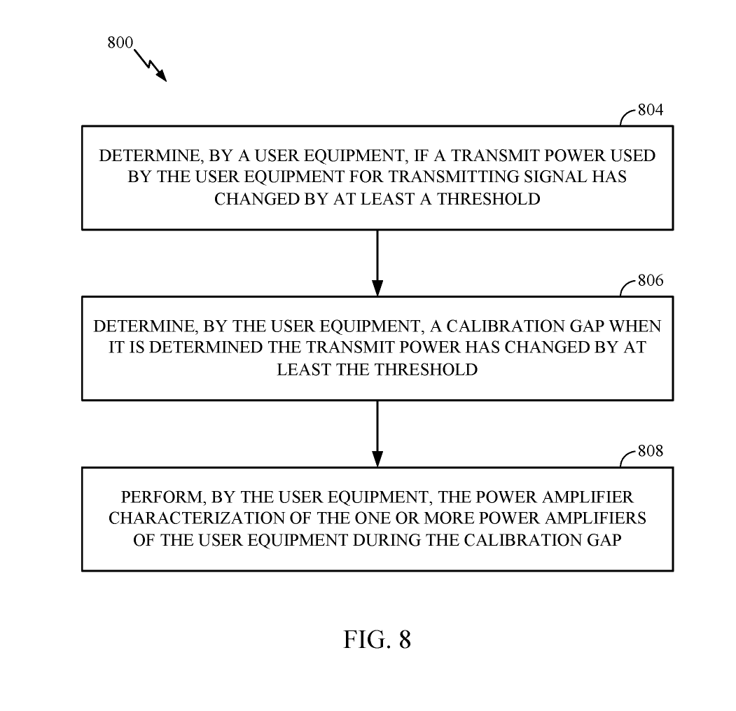

In aspects of this disclosure, the capability information may be transmitted using Radio Resource Control (RRC) signaling according to 3GPP standards or other suitable wireless communication standards. The capability information may also include information indicative of a threshold for determining whether to perform power amplifier characterization as further described herein with respect to FIGS. 7 and 8. In other aspects, the UE may transmit the information indicative of the threshold to the base station separate from the capability information.

At 604, the UE determines if a condition associated with a power amplifier characterization is met to determine whether to schedule a calibration gap. Various conditions may be used to determine whether to schedule a calibration gap. For instance, the condition may be related to a transmit power of the power amplifier, a modulation bandwidth of an antenna layer, a temperature of a transmit chain, power supply variations of the transmit chain, and phased array scan angles of the transmit chain. Some aspects of the condition are further described herein with respect to FIGS. 7-9.

At 606, the UE determines a calibration gap after the condition is met. In certain aspects, the network may determine a suitable period of time to use as a calibration gap or a UE may signal a period of the calibration gap to the network, and the UE may determine to perform the power amplifier characterization (e.g., using a suitable modulation signal) if the condition is met during the network determined calibration gap. The UE may set this period of time and modulation signal as the calibration gap it uses to perform power amplifier characterization.

At 608, the UE performs the power amplifier characterization of one or more PAs (e.g., PA 316 of FIG. 3) of the UE during the calibration gap. The UE may switch a first antenna layer over to receive mode and feed the output of the PA associated with a second antenna layer to the receive chain of the first antenna layer as described herein with respect to FIGS. 4 and 5. The receive chain of the first antenna layer samples the output of the PA associated with the second antenna layer to provide a power amplifier characterization of the PA associated with the second antenna layer. The power amplifier characterization may include distortion information associated with the power amplifier including but not limited to a model of the non-linearity of the PA. The UE may generate distortion information related to the non-linear effects of the PA based on the power amplifier characterization. In aspects of the disclosure, the model of the non-linear effects of the PA may be a Volterra series model. This Volterra series model may be used to compensate for the non-linear effects of the PA using a distortion module as described herein with respect to FIG. 2.

For example, at 610, the UE may perform digital predistortion of one or more signals input into one or more power amplifiers based on the power amplifier characterization (such as a Volterra series). In certain aspects, kernels of the Volterra series model may be adjusted to distort the input signal fed to the PA to improve the EVM and ACLR. In certain aspects, the input signal may be generated by distorting a baseband signal.

In certain aspects, scheduling the power amplifier characterization may be based on a time period, a transmit power threshold, and/or a modulation bandwidth. For example, a calibration gap may be scheduled whenever a transmit power of a transmit chain changes by more than a threshold amount or whenever a modulation bandwidth of the transmit chain increases (or changes by more than a threshold amount) along with some periodicity. In certain aspects, a change in modulation bandwidth by more than a threshold may be a criterion for scheduling a calibration gap, similar to the discussion of the change in transmit power.

In certain aspects, a calibration gap may be scheduled whenever transmission bandwidth configuration for a UL grant changes more or equal to twice or half the size in grant n−1 with the exception that if the UL grant n−2 was the size of UL grant n+/−10%, then a calibration gap is not configured. In certain aspects, a UE is scheduled with a periodical calibration gap with the periodicity according to UE dedicated information. In certain aspects, a calibration gap period starts when a calibration gap was previously configured periodically, or for any other reason, or when the end of the previous UL grant when the UE was scheduled for rank1 transmissions and UE reported >3 dB power headroom (PHR). In certain aspects, a gap length may be the same for all types of gaps (e.g., 50 μs).

FIG. 7 illustrates example operations 700 for performing power amplifier characterization. Operations 700 may be performed by a wireless communications device, such as user equipment (e.g., UE 120 of FIG. 1). Operations 700 begin at 704 by determining, by the UE while the UE is using at least one of a transmit power and a modulation bandwidth for transmitting signals, if power amplifier characterization of one or more power amplifiers of the UE has been performed within a time period by the UE while transmitting signals at least one of within a threshold of the transmit power and using greater than or equal to the modulation bandwidth. In aspects, the time period used by the UE may be 200 milliseconds to 10 seconds in length. This time period may be used to take into account variations in temperature, power supply output, and aging of the UE (e.g., including the PA) without actively monitoring these aspects. In aspects, the UE may determine if power amplifier characterization has been performed by receiving, from a base station, information indicating at least one of the transmit power has changed by at least the threshold and the modulation bandwidth has increased. In some aspects, the UE determines if power amplifier characterization has been performed itself based on information stored at the UE.

At 706, the UE determines a calibration gap when it is determined that the power amplifier characterization of the one or more power amplifiers of the UE has not been performed within the time period by the UE while transmitting signals at least one of within the threshold of the transmit power and using greater than or equal to the modulation bandwidth. In certain aspects, the network may determine a suitable period of time to use as a calibration gap or a UE may signal a period of the calibration gap to the network, and the UE may determine to perform the power amplifier characterization (e.g., using a suitable modulation signal) if it is determined that the power amplifier characterization of the one or more power amplifiers of the UE has not been performed within the time period by the UE while transmitting signals at least one of within the threshold of the transmit power and using greater than or equal to the modulation bandwidth during the network determined calibration gap. The UE may set this period of time and modulation signal as the calibration gap it uses to perform power amplifier characterization. At 708, the UE performs the power amplifier characterization during the calibration gap.

When a UE performs power amplification characterization of a PA when it is operating at a certain transmit power and modulation bandwidth, it may store information regarding the power amplifier characterization in memory (e.g., volatile memory). As discussed, such information may be considered “valid” for the time period starting at when the PA characterization was performed at the certain transmit power and modulation bandwidth. For example, when the PA is operating at the transmit power and modulation bandwidth, the same power amplifier characterization can be used to characterize the PA for the period of time (e.g., as any variations in temperature, power supply output, and aging should not significantly affect the power amplifier characterization for the period of time) so is valid for the period of time. Further, the power amplifier characterization performed for a PA at a first transmit power may also be applicable to the PA operating at any transmit power within a threshold (e.g., +0/−2 dB, 2 dB, etc.) of the first transmit power. In addition, the power amplifier characterization performed for a PA at a first modulation bandwidth may also be applicable to the PA operating at modulation bandwidths less than or equal to the first bandwidth (e.g., PA characterization for wider modulation bandwidth may be used for narrower resource block (RB) allocations). The UE may store information for power amplifier characterization of a PA at one or more transmit powers and/or modulation bandwidths. Each of these one or more power amplifier characterizations may be applicable to a range of transmit powers and/or modulation bandwidths, as discussed. The UE may discard any power amplifier characterizations of a PA when they are no longer valid.

Therefore, in certain aspects, a UE may generally perform PA characterization of a PA when the PA characterization is no longer valid for the transmit power and modulation bandwidth of the PA (e.g., after every time period) to account for any variations in temperature, power supply output, aging, etc., and/or when there is no PA characterization applicable to the PA for the transmit power and modulation bandwidth of the PA.

In certain aspects, the UE may perform PA characterization of a PA if the transmit power changes by more than the threshold and a valid PA characterization is not stored for the new transmit power. Accordingly, if the transmit power changes from a first transmit power where a first PA power characterization is performed to a second transmit power (more than a threshold from the first transmit power) where a second PA power characterization is performed, and then the transmit power changes back to the first transmit power within the time period from when the first PA power characterization is performed, the first PA power characterization may still be used for the PA. However, if the transmit power changes back to the first transmit power after the time period from when the first PA power characterization is performed, the first PA power characterization may not be valid, and a third PA power characterization performed.

FIG. 8 illustrates example operations 800 for performing power amplifier characterization based on a transmit power threshold, in accordance with one or more embodiments. Operations 800 begin at 804 by determining, by the UE, if a transmit power used by the UE for transmitting signal has changed by at least a threshold. At 806, the UE determines a calibration gap when it is determined the transmit power has changed by at least the threshold. The UE may determine if the transmit power has changed by at least the threshold by receiving, from a base station, information indicating the transmit power has changed by at least the threshold. In some aspects, the UE determines if transmit power has changed by at least the threshold itself based on information stored at the UE. In certain aspects, the network may determine a suitable period of time to use as a calibration gap or a UE may signal a period of the calibration gap to the network, and the UE may determine to perform the power amplifier characterization (e.g., using a suitable modulation signal) when it is determined the transmit power has changed by at least the threshold during the network determined calibration gap. The UE may set this period of time and modulation signal as the calibration gap it uses to perform power amplifier characterization. At 808, the UE performs the power amplifier characterization of the one or more power amplifiers of the UE during the calibration gap. In operations 800, the power amplifier characterization is triggered whenever the transmit power changes by more than the threshold. In aspects, the transmit power threshold may be any suitable threshold for improving the DPD including but not limited to 1 dB to 5 dB.

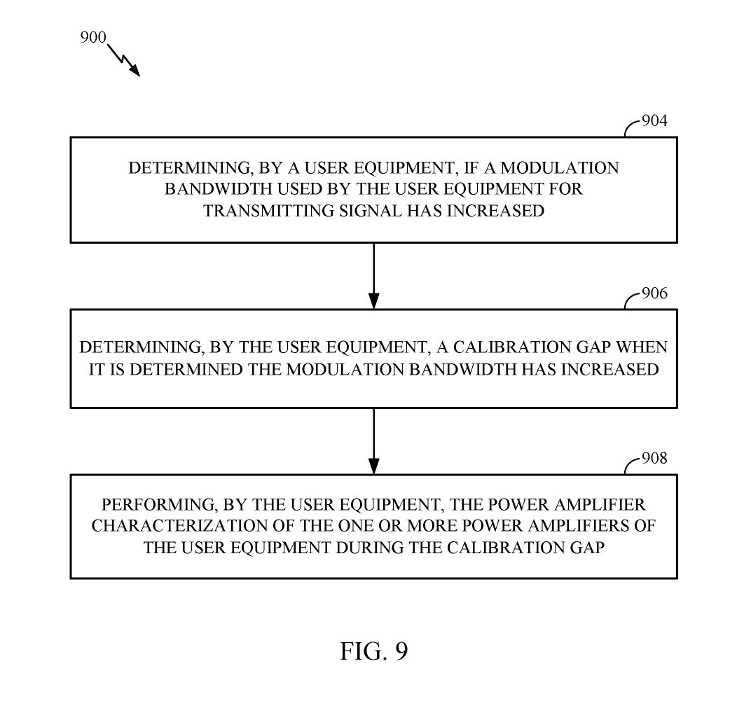

FIG. 9 illustrates example operations 900 for performing power amplifier characterization based on a modulation bandwidth, in accordance with one or more embodiments. Operations 900 begin at 904 by determining, by the UE, if a modulation bandwidth used by the UE for transmitting signals has increased. The UE may determine if the modulation bandwidth has increased by receiving, from a base station, information indicating the modulation bandwidth has increased. In some aspects, the UE determines if modulation bandwidth has increased itself based on information stored at the UE. At 906, the UE determines a calibration gap when it is determined the modulation bandwidth has increased. In certain aspects, the network may determine a suitable period of time to use as a calibration gap or a UE may signal a period of the calibration gap to the network, and the UE may determine to perform the power amplifier characterization (e.g., using a suitable modulation signal) when it is determined the modulation bandwidth has increased during the network determined calibration gap. The UE may set this period of time and modulation signal as the calibration gap it uses to perform power amplifier characterization. At 908, the UE performs the power amplifier characterization of the one or more power amplifiers of the UE during the calibration gap. In operations 900, the power amplifier characterization is triggered whenever the modulation bandwidth increases. In aspects, the modulation bandwidth may be the bandwidth of one or more antennas of an antenna layer.

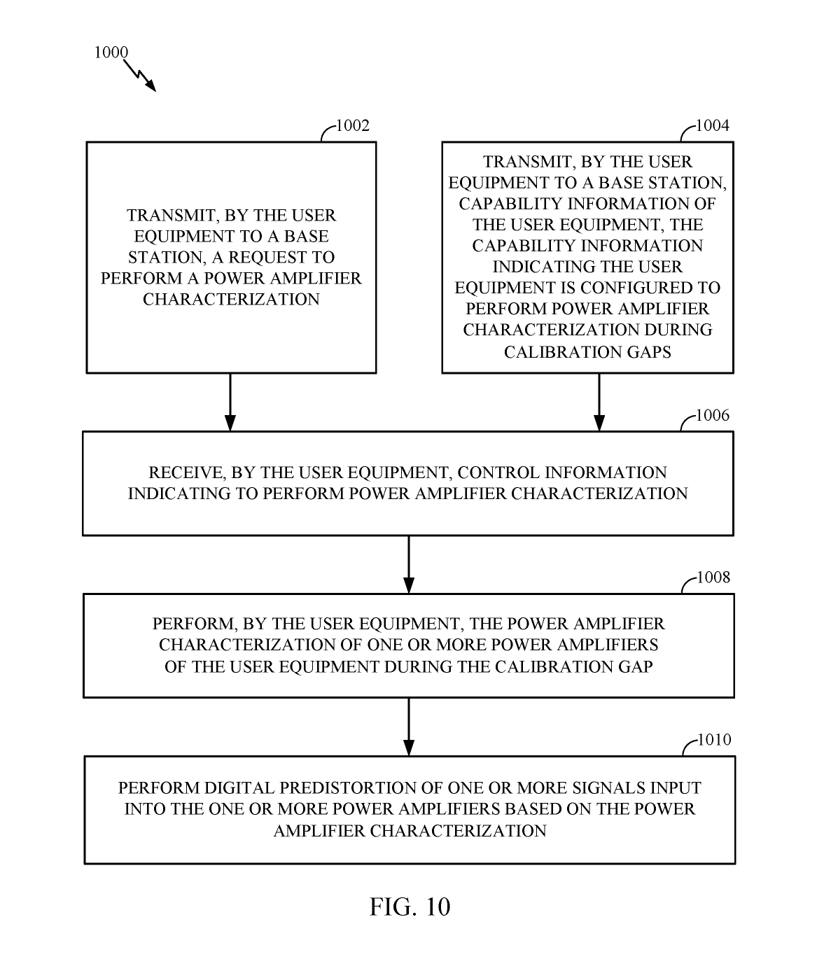

In certain aspects, the UE may also negotiate with the base station when to schedule the calibration gap. For example, FIG. 10 illustrates example operations 1000 for performing power amplifier characterization. Operations 1000 may be performed by a wireless communications device, such as user equipment (e.g., UE 120 of FIG. 1).

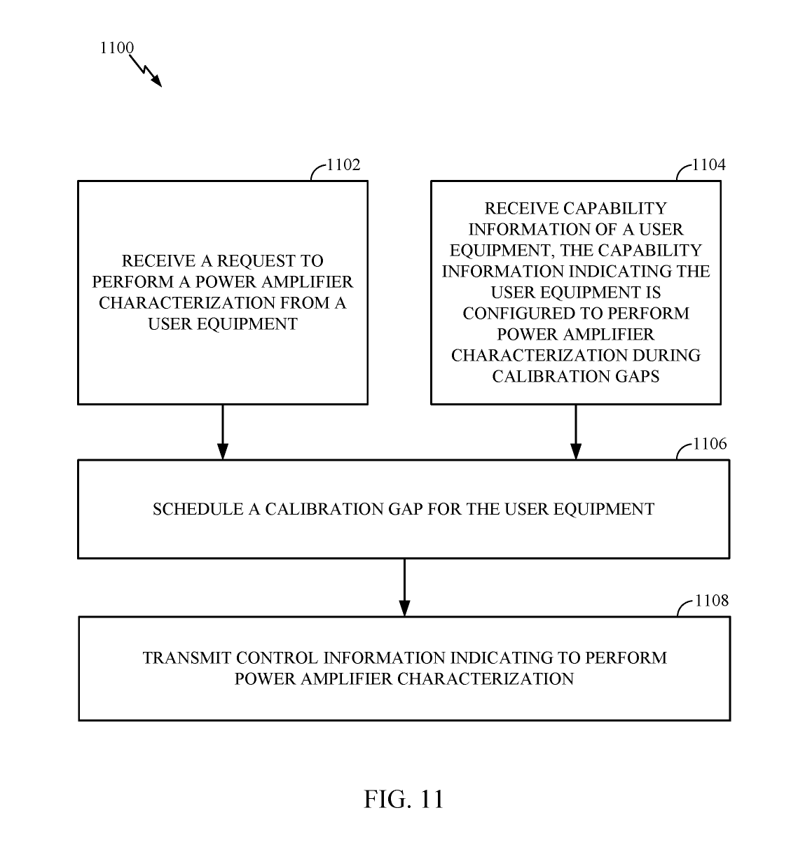

At 1002, the UE transmits, to a base station, a request to perform a power amplifier characterization. For instance, the UE may perform operations 600, 700, 800, or 900 and determine that a power amplifier characterization is needed according to various conditions discussed herein. The UE may then request that the base station schedule a calibration gap for the UE to perform the power amplifier characterization. This request may be included in information transmitted to the base station, such as in a control message. This request may be indicated via power headroom (PHR) reporting by the UE as further described herein with respect to FIG. 11.

At 1004, the UE may also transmit capability information as discussed herein with respect to FIG. 6.

At 1006, the UE may receive control information indicating to perform power amplifier characterization. For instance, the control information may indicate the length of the calibration gap and/or a reduction in uplink resources allocated to the UE. The control information may also be a command to perform the power amplifier characterization as the UE may be programmed in advance with the calibration gap and/or the reduction in uplink resources necessary to perform the power amplifier characterization. The control information may also indicate that a transmit power of the UE has changed by a threshold and/or the modulation bandwidth of the UE has increased as may be used by the UE according to operations 700, 800, and/or 900.

At 1008, the UE performs the power amplifier characterization of the one or more power amplifiers of the UE during the calibration gap as described herein with respect to FIGS. 4 and 5. At 1010, the UE may perform digital predistortion of one or more signals input into one or more power amplifiers based on the power amplifier characterization (such as a Volterra series) as described herein with respect to FIG. 6.

In certain aspects, the base station may monitor the transmissions of the UE and schedule the calibration gap. For instance, FIG. 11 illustrates example operations 1100 for performing power amplifier characterization. Operations 1100 may be performed by a wireless communications device, such as a base station (e.g., base station 110 of FIG. 1).

At 1102, the base station receives a request to perform a power amplifier characterization from a UE. As previously discussed, the request may be in the form of information transmitted to the base station, such as in a control message.

At 1104, the base station receives capability information as described herein with respect to FIG. 6. The base station may use this capability information to monitor the transmit power of the UE and schedule a calibration gap.

At 1106, the base station schedules a calibration gap for the UE that either requested the calibration gap or notified the base station of its capabilities at 1102 or 1104. For instance, the base station may schedule a calibration gap for this UE whenever the base station sends a transmit power control (TPC) command that exceeds a transmit power threshold (e.g., >2 dB) or observes power headroom reporting PHR change that exceeds the transmit power threshold (e.g., >2 dB) for this UE. Not all UEs may need a calibration gap due to different TX architectures implemented. Therefore, 1102 and 1104 serve to inform the base station which UEs can benefit from a calibration gap.

At 1108, the base station transmits control information, which indicates to perform power amplifier characterization, to the UE. The control information may be included in downlink control information (DCI) transmitted over the physical downlink control channel (PDCCH). The control information may be a TPC command to reduce the transmit power of the UE. For instance, the UE may be programmed in advance to initiate a power amplifier characterization upon receiving a TPC command that reduces the transmit power by a threshold value (e.g., 2 dB). The control information may indicate that a transmit power of the UE has changed by a threshold and/or the modulation bandwidth of the UE has increased. In certain aspects, the UE may perform operations 600, 700, 800, and/or 900 upon receipt of the control information.

In certain aspects, under signal compression (also referred to as “compressed mode”), DPD may be dominated by non-linear distortion, which may be relatively independent of channel characteristics. In compressed mode, a single feedback path may be used to determine the PA characterization for the other transceiver front-end TX/RX paths as further described herein. In uncompressed mode, DPD may be dominated by cross-coupling, which may depend on the multiple antenna array elements.

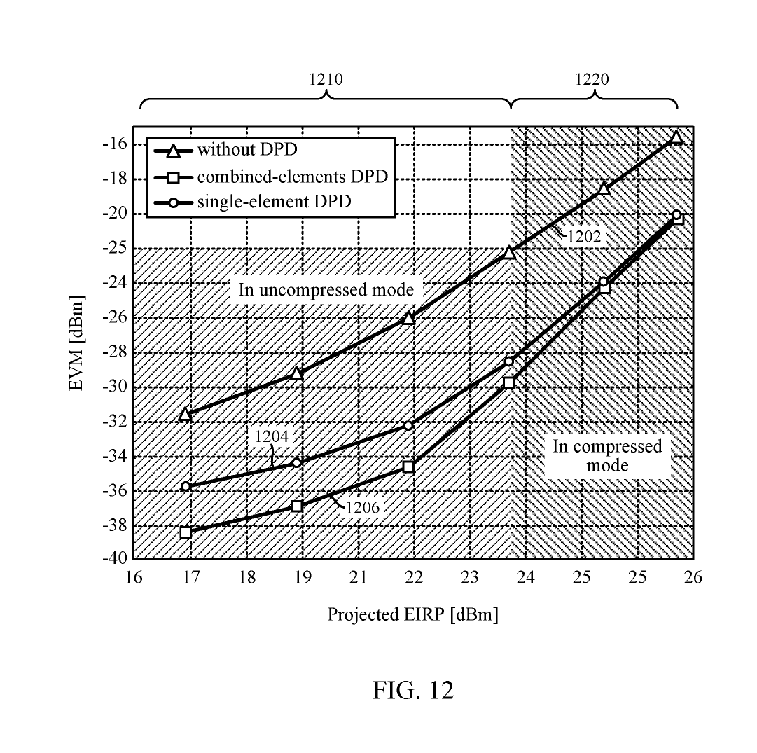

FIG. 12 is a graph of example error vector magnitudes (EVMs) with various DPD implementations, in accordance with certain aspects of the present disclosure. The EVM may provide a metric for in-band distortion. As shown, curves 1202, 1204, and 1206 represent the EVM as a function of effective isotropic radiated power (EIRP) under various DPD implementations. The curve 1202 illustrates the EVMs without DPD; the curve 1204 illustrates the EVMs with DPD based on a single PA element; and the curve 1206 provides the EVMs with DPD based on multiple PA elements. FIG. 12 also depicts the uncompressed mode 1210 and compressed mode 1220 regions of the PA performance. FIG. 12 demonstrates that within the compressed mode region 1220, the single-element DPD curve 1204 performs similar to the multi-element DPD curve 1206.

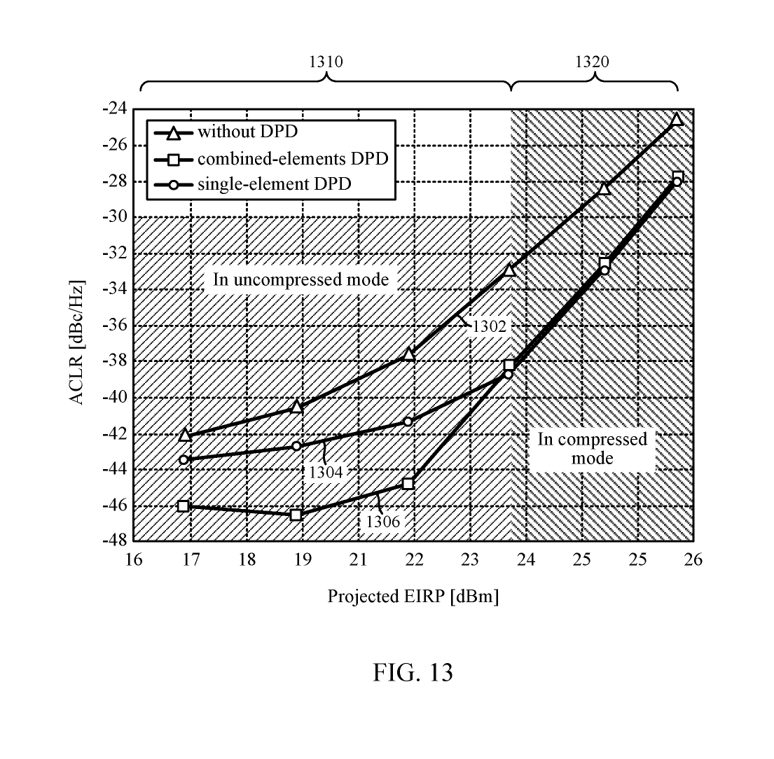

FIG. 13 is a graph of example adjacent channel ratios (ACLRs) with various DPD implementations, in accordance with certain aspects of the present disclosure. The ACLR may provide a metric for out-of-band distortion. As shown, curves 1302, 1304, and 1306 represent the ACLR as a function of EIRP under various DPD implementations. The curve 1302 illustrates the ACLRs without DPD; the curve 1304 illustrates the ACLRs with DPD based on a single PA element; and the curve 1306 provides the ACLRs with DPD based on multiple PA elements. FIG. 13 also depicts the uncompressed mode 1310 and compressed mode 1320 regions of the PA performance. FIG. 13 demonstrates that within the compressed mode region 1320, the single-element DPD curve 1304 performs similar to the multi-element DPD curve 1306. FIGS. 12 and 13 demonstrate that the single-element PA characterization may be used for compressed mode, whereas multi-element DPD may be used for uncompressed mode.

Techniques described herein provide advantages. Scheduling PA characterization while the UE is online enables the UE to compensate for non-linear effects experienced by the PA. For instance, the UE may implement digital predistortion utilizing a robust, adaptable PA characterization over the course of the UEs operating life.

### Example Beamforming

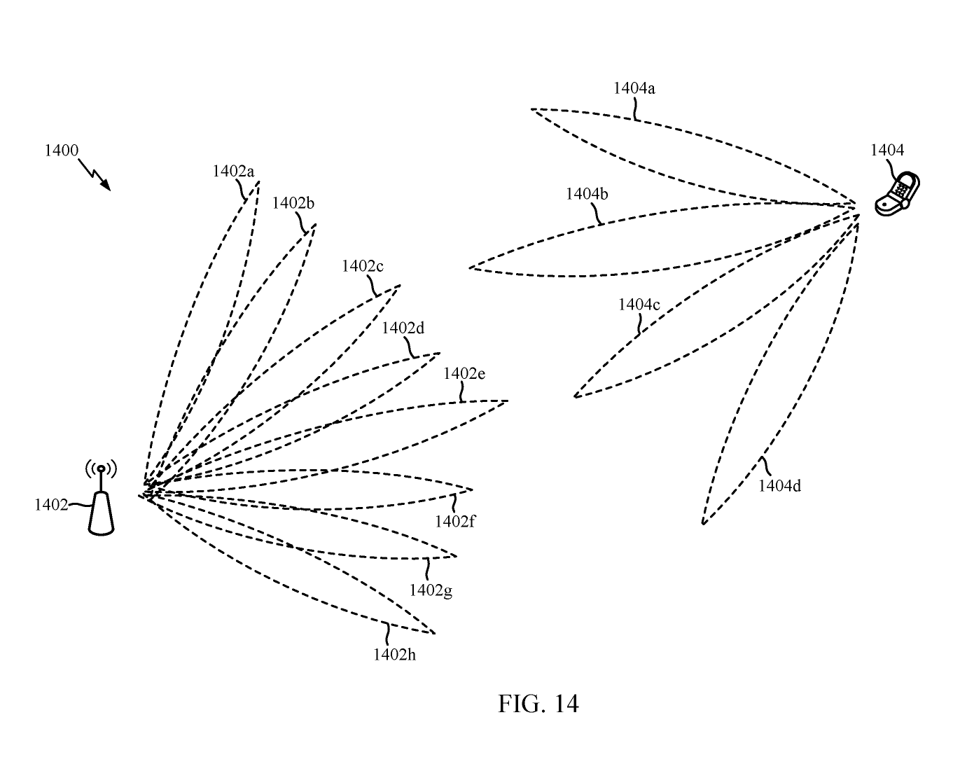

FIG. 14 is a diagram 1400 illustrating a base station 1402 in communication with a UE 1404. Referring to FIG. 14, the base station 1402 may transmit a beamformed signal to the UE 1404 in one or more of the directions 1402a, 1402b, 1402c, 1402d, 1402e, 1402f, 1402g, 1402h. The UE 1404 may receive the beamformed signal from the base station 1402 in one or more receive directions 1404a, 1404b, 1404c, 1404d. The UE 1404 may also transmit a beamformed signal to the base station 1402 in one or more of the directions 1404a-1404d. The base station 1402 may receive the beamformed signal from the UE 1404 in one or more of the receive directions 1402a-1402h. The base station 1402/UE 1404 may perform beam training to determine the best receive and transmit directions for each of the base station 1402/UE 1404. The transmit and receive directions for the base station 1402 may or may not be the same. The transmit and receive directions for the UE 1404 may or may not be the same.

### Example RF Exposure Limit

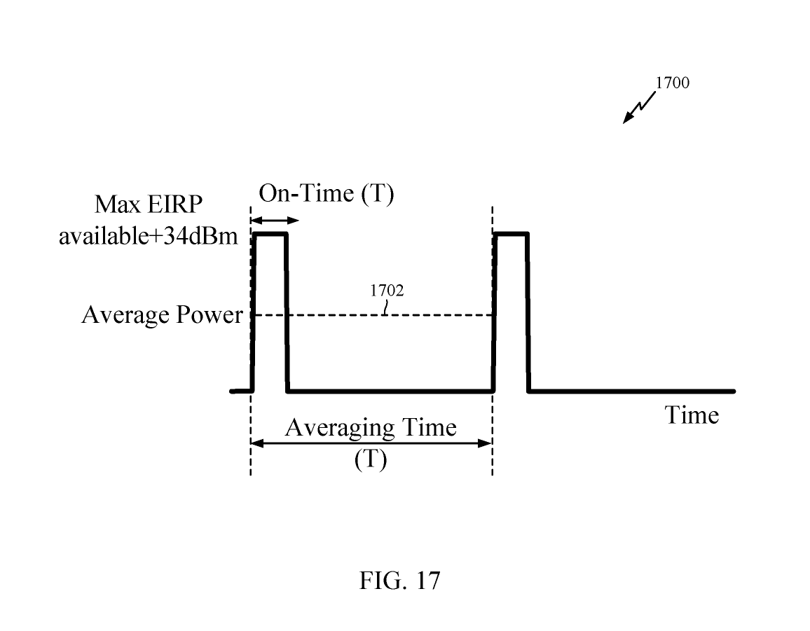

Exposure limits are imposed to limit RF radiation from wireless devices. For example, a specific absorption rate (SAR) limit is imposed for wireless devices communicating in a sub-6 GHz carrier (e.g., communicating in a spectrum at or below 6 GHz). The transmission in a sub-6 GHz carrier system may be close to isotropic and may have a low path loss. The SAR regulatory metric for exposure is a volume metric, e.g., expressed as a power per unit volume. In contrast, a maximum permissible exposure (MPE) limit is imposed for wireless devices communicating above 6 GHz. The MPE limit is a regulatory metric for exposure based on area, e.g., an energy density limit defined as a number, X, Watts per square meter (W/m²) averaged over a defined area and time averaged over a frequency dependent time window in order to prevent a human exposure hazard represented by a tissue temperature change. The higher frequencies above 6 GHz interact with a person's skin surface while the lower frequencies below 6 GHz can be absorbed in volume. An exposure limitation may be indicated for whole body exposure and/or for localized exposure. Exposure limits may be based on an average amount of exposure for a defined time window. An example MPE limit for mmW systems is 1 mW/cm². Thus, this limit may indicate that a power density hitting a person may not exceed 1 mW/cm². Another example limit may be 20 mW/20 cm², e.g., in which the power density needs to be met over a wider area. For a UE, an average MPE measurement may be used, e.g., using a duty-cycle. FIG. 17 illustrates an example of averaging 1700 exposure for a transmission during a time, t, that is only a portion of the averaging time window, T. The transmission may be transmitted at a Max EIRP of +x dBM and will lead to the indicated average power 1702 when averaged over the averaging time T. This allows the UE to transmit at max EIRP of +x dBM for a short period of time within the averaging window so that the average power over the averaging window will be less than the max EIRP.

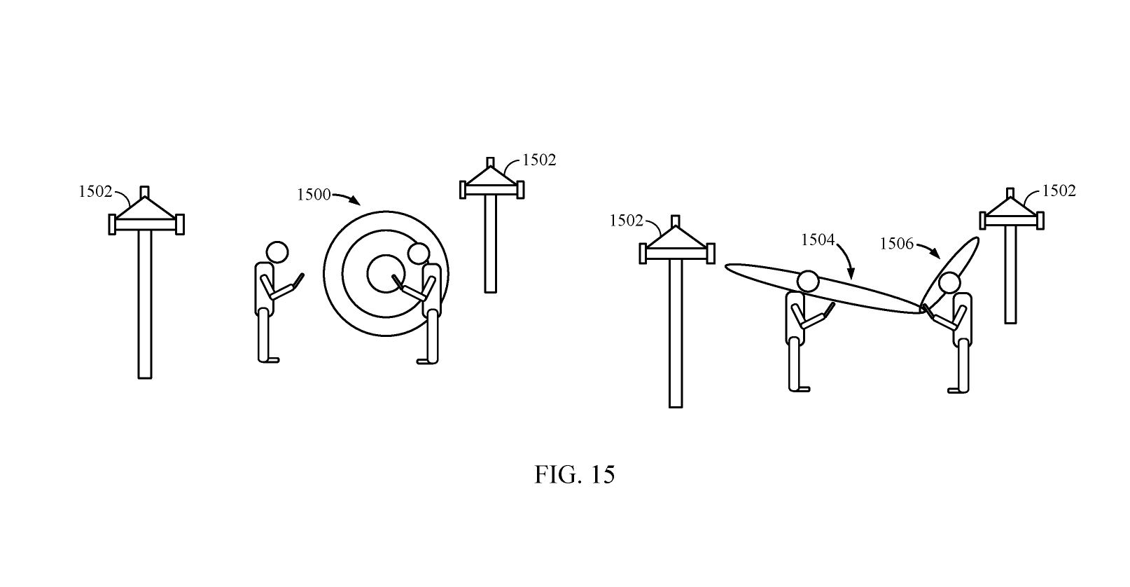

As free space and other losses for mmW systems are much higher than for sub-6 carrier systems, a higher EIRP for transmissions is typically desired. A higher EIRP may be accomplished by using antenna arrays to steer a beam in a desired direction, e.g., as with the example beamforming described in connection with FIG. 14. An example EIRP limit for UE devices in a mmW system, e.g., 24 GHz-60 GHz system, may be 43 dBm. For transportable devices, such as Customer Premises Equipment (CPE), the limit may be higher, e.g., 55 dBm. While a typical UE may operate below the 43 dBm limit, e.g., in the range of 26-34 dBm, there may be a problem in which a transmission beam pointed towards a person's skin could violate the MPE limits. Thus, even while meeting the EIRP limits, a mmW beam from a handheld device might violate an MPE limit when the mmW beam is directed toward a person's body. FIG. 15 illustrates handheld wireless devices wirelessly communicating with base stations 1502. A first handheld device emits a transmission 1500 that is close to isotropic, and a second handheld device wirelessly communicate with base station(s) 1502 using beam forming, e.g., with beams 1504, 1506. For the second handheld device, energy may be concentrated in the beam direction, e.g., 1504, 1506, through the use of multiple antenna elements transmitting in a manner to constructively add in a particular direction.

Static power limits for transmissions from UEs may ensure that MPE limits are met at all times. However, such static power limits could require substantial back-off in power at the UE and may lead to a poor uplink range for the UE. A static power back off rule may be based on a distance at which a detector can measure an MPE violation. In order to ensure that the UE maintains conformance with exposure limits while providing an effective range, a UE may perform exposure measurements to detect actual exposure conditions. When the UE determines a problematic exposure condition, the UE may respond in any of a variety of ways to ensure conformance with the exposure limits. The UE may reduce transmission power and/or switch antenna arrays in response to detecting an exposure condition that would violate the limit.

Thus, the UE may perform an in band exposure measurement, e.g., an MPE measurement, to detect the presence of a person, e.g., a hand or other body part in a particular beam direction. One example of an MPE measurement may be made using a frequency modulated continuous wave radar measurement. For example, the UE may transmit a radio signal with at least one antenna element and the receiver may detect echoes from objects in the path of the signal. This detection may enable the UE to detect an obstruction and a distance to the obstruction. The UE may respond based on the assumption that the obstruction is a portion of a person's body in the path of a transmission from the antenna. Example detection methods include xpol and radar. In the radar example, the radar signal may sweep the signal in frequency over a wide bandwidth and may radiate in the band in which the UE will communicate with a base station. In the x pol example, the transmission may include only a single tone rather than a wideband signal.

However, such an in band exposure measurement may cause interference to data or control transmissions within the communication system. Additionally, in band measurements may be inaccurate due to other transmissions in the communication system. In order to make accurate exposure measurements without causing interference to other transmissions within the communication system, the UE may make an exposure measurement based on resources that avoid interference to other data/control transmissions. For example, the resources may comprise a cell specific resource available for MPE measurements. Determinations may be made by the UE or by the network to manage interference that UEs performing measurements may cause to each other and to other data/control transmissions. The UE may then determine whether to adjust a transmission characteristic based on the exposure measurement.

Multiple UEs making simultaneous MPE measurements may lead to interference among each other and inaccurate MPE measurements. However, the power levels for MPE measurement are generally low. Furthermore, measurement occasions for UEs can be randomized over the cell specific resource occurrences in order to limit this interference. Additionally, while a false detection of MPE meeting the limit may lead to inefficiency, it may not be catastrophic.

### System Wide Gap

One example of a resource for MPE measurement is a system-wide gap. However, a system wide gap for MPE measurement may lead to system inefficiencies, e.g., if the system wide gap needs to be used frequently by the UEs. Such a system wide gap may cause many UEs to take a measurement at the same time, e.g., leading to inaccurate/noisy measurements. The inaccuracy may be improved by randomizing a burst load of MPE measurements. Thus, MPE transmission signals may be randomized over different system wide resources. In this example, UE may be configured to randomize their MPE measurements among a plurality of system wide gap occasions. By randomizing the MPE transmission signals rather than using a selected sub-set of resources may help to avoid high levels of interference. The randomization may improve system inefficiency by improving the accuracy of the MPE measurements and avoiding false detection of an exposure condition.

### An Unscheduled Resource

In another example, the UE may make the measurement based on an existing resource opportunity that will enable the UE to make a measurement without significantly disrupting system operation and performance. In 5G systems, dynamic TDD may be employed. Thus, data resources can be dynamically configured to be uplink or downlink based on control channel indications. In this example, the UE may use a resource during which it has not been scheduled for downlink or uplink data to make an MPE measurement. Although a UE may determine, upon decoding a control channel, that the UE has not been scheduled for data in a resource, it might not be desirable to reuse the resource because another downlink or uplink transmission in the cell may lead to inaccuracies in the MPE measurement. Similarly, MPE measurements during resources carrying downlink synchronization signals may lead to inaccuracies in the MPE measurement.

### Gap Period

In another example, the UE may use a gap period between downlink and uplink resources to make the MPE measurement. Use of the gap period may lead to inefficiency in MPE measurement, e.g., because when the UE is scheduled for downlink data, the UE must first complete the reception of the downlink data. Thus, depending on the UE's distance from the base station, the reception delay may consume a portion of the gap period before the UE can commence with an MPE measurement. Additionally, when the UE has to send an uplink control channel, a further restriction is placed on the ability to measure during the gap period. As well, another UE located further away in the cell may perform timing advanced transmission leading to interfered and inaccurate MPE measurement. The UE may receive transmissions from distant base stations that are coarsely synchronized even after the UE has entered the gap period, thereby leading to an interfered, inaccurate MPE measurement.

MPE detection resource may be located in guard tones between RACH resources or in guard tones between RACH resources and data/control resources. For example, RACH resources may use 139 tones in communication over 6 GHz. However, 144 tones may be reserved for RACH bandwidth in communication systems over 6 GHz. In this example, there will be 5 guard tones around the actual RACH sequence that may be available for MPE measurement.

### Cell Specific Resource

In another example, the UE may perform the MPE measurement during a cell specific resource that is available for MPE measurement. Examples of a cell specific resource include any of a RACH resource, a beam failure recovery resource, or a scheduling request (SR) resource. A resource may comprise a downlink resource or a synchronization signal (SS) resource.

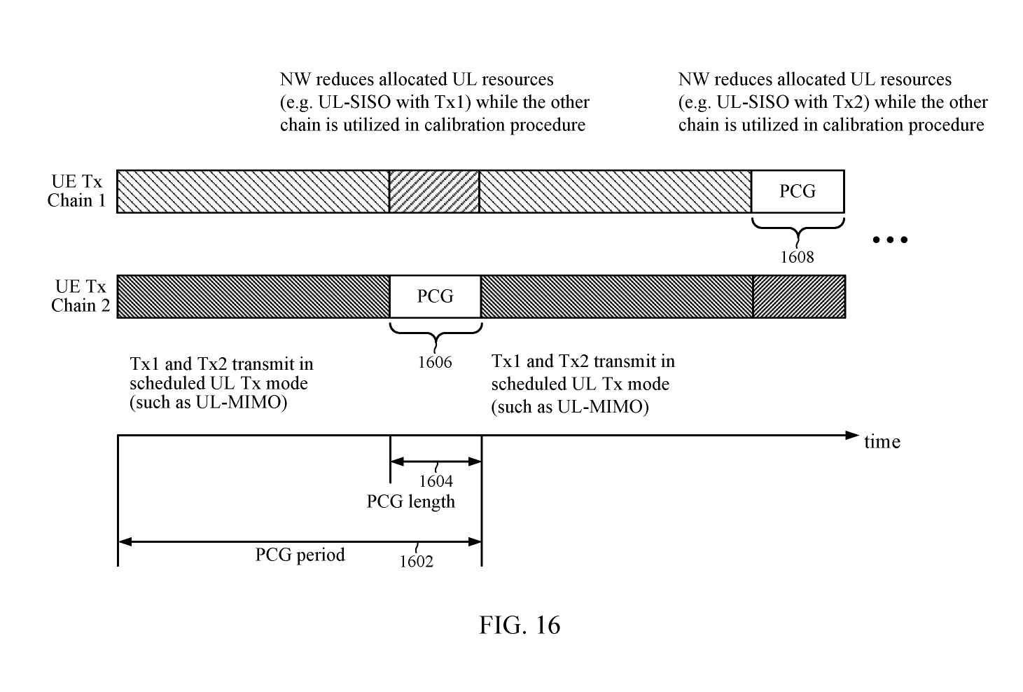

A resource may comprise a power amplifier calibration gap, such as the calibration gap depicted in FIG. 5. The power amplifier calibration gap may be a set of resources of an uplink allocated for power amplifier calibration. One example configuration of a power amplifier calibration gap is illustrated in FIG. 16, in accordance with certain aspects of the present disclosure.

In this example, a power amplifier calibration gap (PCG) may be defined by the PCG period 1602 and PCG length 1604. The configuration itself may be triggered by a UE request, by a network decision (i.e. according to gNB implementation), in a semi-persistent manner, or in the specification. The exact pattern can be determined based on existing examples of gaps in 3GPP, such measurement gaps or uplink compensation gaps for eMTC/NB-IoT or based on new analysis. The gaps may be very infrequent so as to minimize the overall impact on system throughput; for example, the PCG period 1602 does not need to be any shorter than 1 second, and PCG length 1604 can be several symbols.

In the example case of UL-MIMO transmission, during the sustained period of data transmission, the UE utilizes both RF chains (UE Tx Chain 1 and UE Tx Chain 2) to transmit UL-MIMO. During the PCG, the UE is allocated fewer UL resources such that it becomes possible for the UE to continue transmission to the gNB on one Tx chain (e.g., UE Tx Chain 1) while utilizing the other chain (e.g., UE Tx Chain 2) in the calibration procedure. While the calibration procedures themselves are up to UE implementation, the UE should be able to utilize any UL signal or channel during this gap.

The PCG may be used for MPE measurement. For example, in FIG. 16, UE Tx Chain 2 may perform the MPE measurement during the first PCG 1606 while UE Tx Chain 1 transmits data to the network. Later, UE Tx Chain 1 may perform the MPE measurement during the second PCG 1608 while UE Tx Chain 2 transmits data to the network.

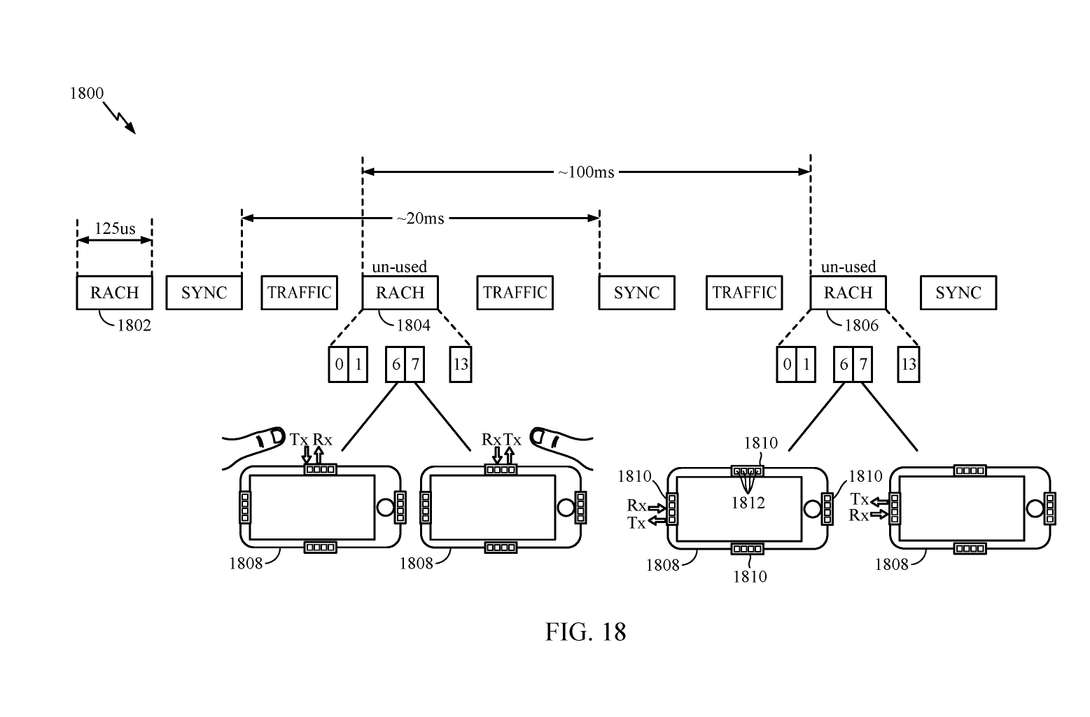

Examples will be described in connection with the RACH example. However, aspects may similarly be applied to a beam failure recovery resource or a scheduling request resource. FIG. 18 illustrates an example of MPE measurement 1800 performed during unused RACH resources 1804 and 1806. RACH resource 1802 might not be used for MPE measurement, e.g., when the UE needs the resource for RACH, when the UE determines autonomously not to perform a measurement during the RACH resource, or when the UE receives an indication to refrain from performing an MPE measurement during the RACH resource 1802. As illustrated in FIG. 18, MPE measurements may be performed using different antenna sub arrays. The example device 1808 in FIG. 18 has four antenna modules 1810, each antenna module comprising multiple elements 1812, also referred to as sub arrays. In a given unused RACH subframe, a same antenna module 1810 may be used. For example, multiple elements 1812 from the same antenna module 1810 may be measured to improve detection. Each antenna pair, e.g., a transmitter/receiver pair, may have its own MPE beam index in the antenna module 1810. A single detection method may be employed, e.g., X-pol or radar. For example, the antenna module 1810 may select the detection method to be used. The selection may be based on a comparison of a moving averaged uplink power against a threshold. For X-pol, the threshold may be less than +24 dBM. For radar, the threshold may be greater than +24 dBm.

For example, a RACH resource is predictably an uplink resource, without concern for downlink transmission interference. The UE may use the RACH resource for MPE measurement when the UE does not need to use the resource for performing RACH or beam access recovery. Use of the RACH resource provides a number of benefits. The RACH resource is predictably a UE transmit occasion in contrast to data resources. The RACH resource is designed for low utilization in order to enable UEs to obtain access to the system quickly and reliably. Thus, the RACH resources should have less inaccuracy in MPE measurement. RACH opportunities occur relatively often, e.g., in comparison to MPE measurement needs. For example, a RACH resource may occur every 5-20 ms. As well, a RACH failure may not be catastrophic, as a randomized retry is typically supported with power ramping. Thus, a UE that fails RACH due to interference caused by MPE measurement should have an opportunity to retry.

While a RACH resource provides a predictable uplink transmit opportunity for MPE measurement, a number of interference issues may apply. In a first example of potential interference, a transmission from another UE may cause interference to the MPE measurement. For example, if a MPE measurement is made using power level of −50 dBm, and the other UE uses a power level of 23 dBm for transmitting a RACH. If the distance between the UE transmitting RACH and UE measuring MPE is 1 m, then at 28 GHz, the interference level will be approximately −38 dBm and MPE detection will fail. Statistically, the chances of interference from another UE RACH transmission are low, because the RACH channel utilization is typically low by design.

Furthermore, this example also assumes that the antenna sub-array for MPE detection is the sub-array experiencing the interference. An MPE signal with a 20 dB attenuation will be received at −70 dBm. A UE simultaneously transmitting RACH at 30 dBm from a distance of about 50 m away will make the SNR of detection around 0 dB. The MPE detection signal may be designed for such a scenario.

A UE may autonomously determine resources for MPE measurement. For example, a UE may perform MPE measurement during any of a resource for which the UE is not scheduled, a system gap, a guard resource, a RACH resource, a beam failure recovery resource, an SR resource, an SS resource, etc. The UE may determine a transmission power for the MPE measurement, e.g., based on downlink path loss values. The UE may perform the MPE measurement using antenna sub-arrays selected based on listening directions of the base station, e.g., based on the UE's knowledge of the base station's listening directions for RACH resources. A sub-array may include a subset of antenna elements within an array of antenna elements. For example, the UE may perform MPE measurement using antenna sub-arrays based on a listening direction of the base station having a reduced quality.

The UE may determine whether to make an MPE measurement based on an interference power detected in a RACH resource, e.g., by listening for interference in a RACH slot. The UE may use the detected interference power as a measurement of system load on the RACH resource. Thus, the UE may determine whether to perform MPE measurement based on a measurement of system load on a particular resource. For example, UE may measure MPE using a RACH resource when system load is measured to be below a threshold. RACH resources may include multiple sub-resources that correspond to different Synchronization Signal (SS) blocks within an SS burst set. The UE may select an SS block, e.g., an SS block having a reduced signal strength, and perform the MPE measurement based on a corresponding RACH sub-resource for the selected SS block. A duration of a RACH resource may be a single slot, multiple slots, or a subset of symbols within a slot. Thus, the UE may select among the resources available for MPE measurement based on resources during which the UE will likely experience and/or cause less interference when performing the MPE measurement.

In other aspects, additional management of the cell specific resource may be employed by the network to control use of the cell specific resource for MPE measurement. Thus, rather than having a UE autonomously determine resources for MPE measurement, a network may control or manage resources used for MPE measurement, e.g., by broadcasting or otherwise signaling indications of resources that may be used for MPE measurement.

In one example, the base station may indicate when RACH occasions, or other available resources, are open for MPE measurement only. In a second example, the base station may indicate that the RACH occasions, or other resources, are available for RACH only. In a third example, the base station may indicate to the UE that the RACH occasions, or other resources, are available for both RACH and MPE measurement. Thus, the network may indicate when an available resource may be used for MPE measurement, and the UE may refrain from using the available resource for MPE measurement unless the indication is received by the network. Alternately, the network may indicate when an available resource may not be used for MPE measurement, and the UE may use the available resource for MPE measurement unless the indication is received by the base station.

The base station may make an indication in any of a MIB, SIB, other system information, MAC CE, DCI, or RRC message. The indication may also be provided to the UE in a message from another carrier, e.g., from an LTE carrier or an 5G sub-6 carrier. For example, a unicast RRC message may be used to indicate to MPE-measuring devices when the devices can or cannot make a measurement in the cell specific resource. In one example, the indication may limit, or otherwise reduce, the use of the resource for MPE measurement.

The network may indicate a rise-over-thermal level that is permitted for MPE measurement for each UE. The network may also indicate a maximum receive power, which indicates the maximum power at which a transmission for MPE measurement from a UE may be received by a base station. The UE may select an SS block and a corresponding RACH sub-resource for MPE measurement to meet maximum receive power limit. For example, the UE may select transmitted SS blocks that the UE cannot detect in order to determine a corresponding resource for MPE measurement.

The network may also explicitly schedule periods for MPE measurement. The scheduled period may be based on an amount of pending uplink data to be transmitted for a UE. Thus, the network may be aware of which UEs have a need to transmit uplink data and may schedule resources for MPE measurement accordingly. In scheduling periods for MPE measurement, the network may group UEs into groups that may perform MPE measurement in a particular resource, e.g., in groups having disparate path loss.

In managing the resources available for MPE measurement, the base station may use a measure of short-term averaged RACH loading to make a determination regarding whether to allow MPE measurement in a RACH resource. There may be a time and spatial correlation in RACH usage, e.g., a greater RACH load during peak hours or a greater load in particular venues, such railway stations, etc. The time and spatial correlation may be used by the base station to predict RACH resource use and to reduce RACH resource use for MPE measurements during times having an increased RACH load and/or in locations having an increase RACH load. Similarly, the base station may use a prediction of RACH resource loads in time and physical location to allow an increased amount of MPE measurement using RACH resources during times predicted to have a lower RACH load and/or in locations predicted to have a lower RACH load.

In a second example of potential interference, an MPE measurement from a first UE may interfere with RACH detection of another UE. The power spectral density of the UE performing MPE measurement may be limited to address this potential interference problem. For example, a cell-edge UE having approximately 140 dB path loss may need to perform RACH in the system. A −6 dB SNR may be needed to detect the signal, and the UE may transmit over 1 RB of bandwidth (˜1.44 MHz at 120 KHz SCS). With a 5 dB base station Noise Figure (NF), the noise power in that BW may be −107 dBm. Therefore, the sensitivity for detecting the RACH may be around −113 dBm. If a target rise-over-thermal noise allowed by a single UE measuring MPE, as seen at the base station, is set at −20 dB and that UE has a path loss of 60 dB to the base station over an approximate distance of 1 m), then, the power spectral density of the UE performing MPE measurement may be limited to −67 dBm over 1.44 MHz. This limit might be prohibitively low to make the MPE measurement. Therefore, similar to the first example of potential interference, a network may manage or control resource use for MPE measurement.

However, if the UE is just 10 m away from the base station, then the power of the UE performing MPE measurement can be increased by 20 dB to create the same level of interference as the UE that is only 1 m away from the base station. At −47 dBm per 1.44 MHz, the MPE measurement becomes much more practical, and the resources may be used without an explicit network indication. Thus, the UE may use the available resources without network management or control, e.g., as an interferer below 20 dB will cause negligible degradation to RACH performance of the other UE.

With multiple UEs performing MPE measurement simultaneously, e.g., with 10 UEs performing simultaneous MPE measurement each from a 10 m distance, the total interference power affecting the RACH is still 10 dB below the noise limit. Each user may make a full MPE measurement over a single RACH resource and may not need to take another measurement for approximately 100 ms. Additionally, a RACH resource may occur every 20 ms. Thus, the available RACH resources may provide capacity for 50 UEs at a 10 m distance to perform MPE measurements without disrupting RACH performance. UEs will likely be distributed in various points in the cell. This distribution may enable UEs at an additional distance to perform additional MPE measurements without disrupting RACH performance. This may be desirable, as UEs that are farther from the base station are more likely to violate an MPE limit.

In certain aspects, a UE may use a knowledge of the base station's listening direction in order to perform MPE measurements on antenna sub-arrays corresponding to a poor listening direction for the base station. Thus, the UE may select antenna sub-arrays of a particular antenna module having a reduced quality as a listening direction for the base station to use in making MPE measurements. For example, RACH resources may be divided into intervals having a correspondence with SS blocks. This may allow the UE to determine a quality of the listening direction. A UE needing to measure MPE may be, e.g., in a connected state with beam measurements being available. Thus, the UE may be able to schedule its MPE measurement to match antenna sub-arrays for which the RACH listening direction at the base station is poor.

In a third example of potential interference, multiple UEs, each measuring MPE, may cause interference among each other's MPE measurements. Power level limits may be used to limit interference among MPE measurements. Additionally, randomized times for MPE measurement and randomized use of antenna sub-arrays to make MPE measurements may reduce the severity of this problem. If this type of interference is a problem, a base station may coordinate MPE measurement in a controlled mode. For example, the base station may coordinate the number of UEs performing MPE measurement in a given resource. Additionally, the base station may group sets of UEs into groups having disparate pathloss, e.g., wherein the UEs within a grouped set have different levels of pathloss, and enable the group of UEs to perform MPE measurement in a particular resource in order to reduce a level of interference to the MPE measurement of each UE.

When the MPE measurement indicates an exposure condition, the UE may take any of a number of actions in order to comply with MPE limits. For example, the UE may reduce a transmission power. The UE may switch transmission to a different antenna array, e.g., to an antenna array that is unobstructed by the person's body. This may change the transmission direction. The UE may operate to increase a transmission power when the MPE measurements indicate that an antenna array is unobstructed by a person's body. Similarly, the UE may reduce the transmission power upon detection of an obstruction based on the MPE measurement.

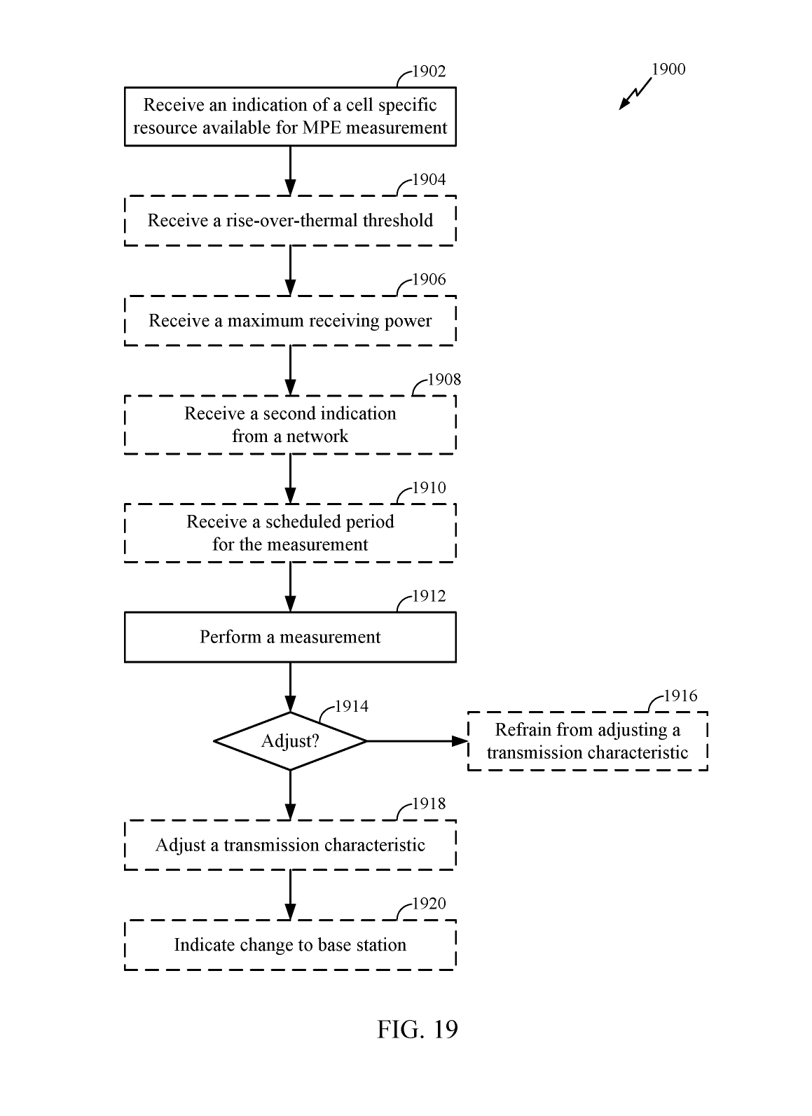

FIG. 19 is a flowchart 1900 of a method of wireless communication. The method may be performed by a UE (e.g., the UE 120, 1404, 1808, 2350, the apparatus 2002, 2002′). Optional aspects are illustrated using a dashed line. At 1902, the UE receives, from a base station, an indication of a cell specific resource. For example, the indication may indicate cell specific resources available for an exposure measurement, e.g., MPE measurement. The cell specific resource may be contained within a system gap, e.g., a system wide gap configured for the measurement. The cell specific resource may comprise an uplink cell specific resource. The cell specific resource may include a guard resource between a RACH resource and a data or control resource or a guard resource between two RACH resources in the frequency domain. The cell specific resource may comprise at least one of a RACH resource, a beam failure recovery resource, or an SR resource. The cell specific resource may comprise an existing resource opportunity, e.g., an unscheduled uplink resource and/or a gap between a downlink transmission and an uplink transmission. The cell specific resource may comprise a downlink resource. The cell specific resource may comprise at least one SS resource, e.g., the UE may perform the measurement based on an SS block for which the UE did not detect a signal, e.g., when the UE detects a low RSRP. Thus, the UE may perform the measurement during the transmission of an SS block that the UE did not detect.

At 1912, the UE performs a measurement based on the cell specific resource. The UE may determine a transmission power for performing the measurement based on downlink path loss values. For example, the UE may autonomously determine the transmission power for the measurement based on downlink path loss, or may determine the transmission power for the measurement further based on an indication from the base station.

In one example, the UE may perform the measurement based on scheduling configuration, where the UE performs the measurement based on a resource for which the base station has not scheduled the UE. Thus, the UE may receive a control channel and determine an unscheduled resource to use for performing the MPE measurement.

In an example in which the cell specific resource comprises a RACH resource, the UE may schedule at least one sub-array for performing the measurement based on a RACH resource listening direction. The UE may further determine whether to perform the measurement in a particular RACH resource based on an interference power received in a prior RACH resource. This may enable the UE to assess the system load for the RACH resource, e.g., based on the detected interference power during the prior RACH resource.

The RACH resource may comprise multiple sub-resources, each sub-resource corresponding to a different SS block within an SS burst set. The duration of the RACH resource may comprise at least a subset of symbols within a slot. For example, the RACH resource available for MPE measurement may comprise a single slot. In another example, the RACH resource may comprise multiple slots. In yet another example, the RACH resource may comprise a subset of symbols within a slot. The UE may select an SS block and perform the measurement at 1912 based on a corresponding RACH sub-resource for the selected SS block. For example, the UE may select an SS block based on signal strength, e.g., an SS block having a reduced signal strength. If the UE detects a low signal strength, e.g., RSRP, for an SS block, the low signal strength may indicate the base station is transmitting in a different direction at that time. By selecting an SS block having a reduced signal strength for performing the MPE measurement, the UE reduces the potential interference caused by the MPE measurement and the potential for inaccuracies in the MPE measurement. Similarly, during RACH resource within a slot, the base station may also listen to different directions. It may be beneficial for the UE to perform MPE measurement during these times, because the UE will be less likely to interfere with another UE's signal.

The network may control use of the resource for MPE measurement. For example, the UE may receive a second indication from the network at 1908 regarding use of the cell specific resource for MPE measurement. In one example, the UE may receive a second indication from a network that the cell-specific resource may be used for the measurement. The UE may be configured to refrain from using the resource for MPE measurement, unless the UE receives the indication that the resource may be used for MPE measurement. In another example, the UE may receive a second indication from the network that the cell specific resource may not be used for the measurement, which may cause the UE to refrain from using the resource for MPE measurement. For example, the UE may be free to use the resource for MPE measurement, unless an indication is received from the base station letting the UE know that the resource may not be used for MPE measurement.

The indication may indicate the ability to use the cell specific resource for the measurement and may comprise any of a parameter in a MIB, a SIB, other system information, a Medium Access Control (MAC) Control Element (CE), Downlink Control Information (DCI), a Radio Resource Control (RRC) message, or in a message from another carrier (e.g., LTE carrier or 5G sub-6 carrier). The indication may place a limit on, or otherwise throttle or reduce, the use of the cell specific resource for the measurement. The indication regarding use of the cell specific resource may also be indicated in a second indication at 1908, separate from the indication of the cell specific resource at 1902.

At 1910, the UE may receive a scheduled period for the measurement from the base station. Thus, the scheduled period for a UE to perform MPE measurement may be explicitly controlled by the base station. In another example, the period for MPE measurement may be statistically controlled, e.g., the base station may indicate to the UE that it may transmit MPE signals a number N times in a duration of T seconds. The base station may indicate to the UE that during a number C of cell specific resources or during a number S of system wide gaps, the UE may randomly select resources within the cell specific resources/system wide gap for the transmission of the MPE signal.

The UE may receive additional information from the base station that controls the MPE measurement. For example, at 1904, the UE may receive a rise-over-thermal threshold for the measurement from a base station. The UE may then use the indicated rise-over-thermal threshold when performing the MPE measurement. At 1906, the UE may receive a maximum receiving power at which a transmission for the measurement may be received at a base station. The UE may use the received maximum receiving power to determine a transmission power for the MPE measurement performed at 1912.

In another example, the UE may perform the measurement during the cell specific resource based on an uplink grant from the base station, e.g., gNB. For example, the UE may perform the measurement when the base station has not scheduled any uplink data to the UE in a same resource, e.g., slot. For example, when a minimum gap of N slots may be provided between PDCCH containing an UL grant and the corresponding PUSCH. In one example, the base station may schedule PUSCH in frequency division multiplexed regions of the cell specific uplink resource (e.g. RACH). In another example, the base station may schedule PUSCH in the same time-frequency regions of cell specific uplink resource (e.g. RACH) by using multiple reception panels/subarrays. For example, one panel may receive RACH while the panel receives PUSCH in the same time-frequency resources. If the cell specific uplink resource (e.g. RACH resource) occurs in slot X, the UE may monitor PDCCH until slot X-N to check whether the UE has been scheduled any uplink data/control in slot X. If the UE has been scheduled uplink data/control in slot X, UE may refrain from performing any MPE measurement in slot X and may instead transmit the uplink data/control. If the UE has not been scheduled uplink data/control in slot X, the UE may perform MPE measurement in slot X.

At 1914, the UE determines whether to adjust a transmission characteristic of the user equipment based on whether the result of the measurement performed at 1912 meets a threshold. The transmission characteristic may comprise any combination of a transmission power, a transmission direction, an antenna sub-array selection, or an antenna module selection. For example, when an MPE measurement meets the threshold, the measurement may indicate an obstruction on the antenna element by a person's body. In response to detecting such an obstruction, at 1918, the UE adjusts a transmission characteristic of the user equipment when the measurement meets the threshold. The UE may reduce a transmission power and/or switch antenna elements for transmission in order to comply with MPE limits. In another example, the threshold may indicate that there is no potential problematic exposure condition for a person. In this example, the UE may adjust the transmission characteristic at 1918 by increasing the transmission power and/or switching to a more preferred antenna element. When a transmission characteristic is changed at the UE at 1918, the UE may indicate to the base station the adjustment of the transmission characteristic at 1920. In contrast, when the threshold is not met at 1914, the UE may refrain from adjusting a transmission characteristic at 1916.

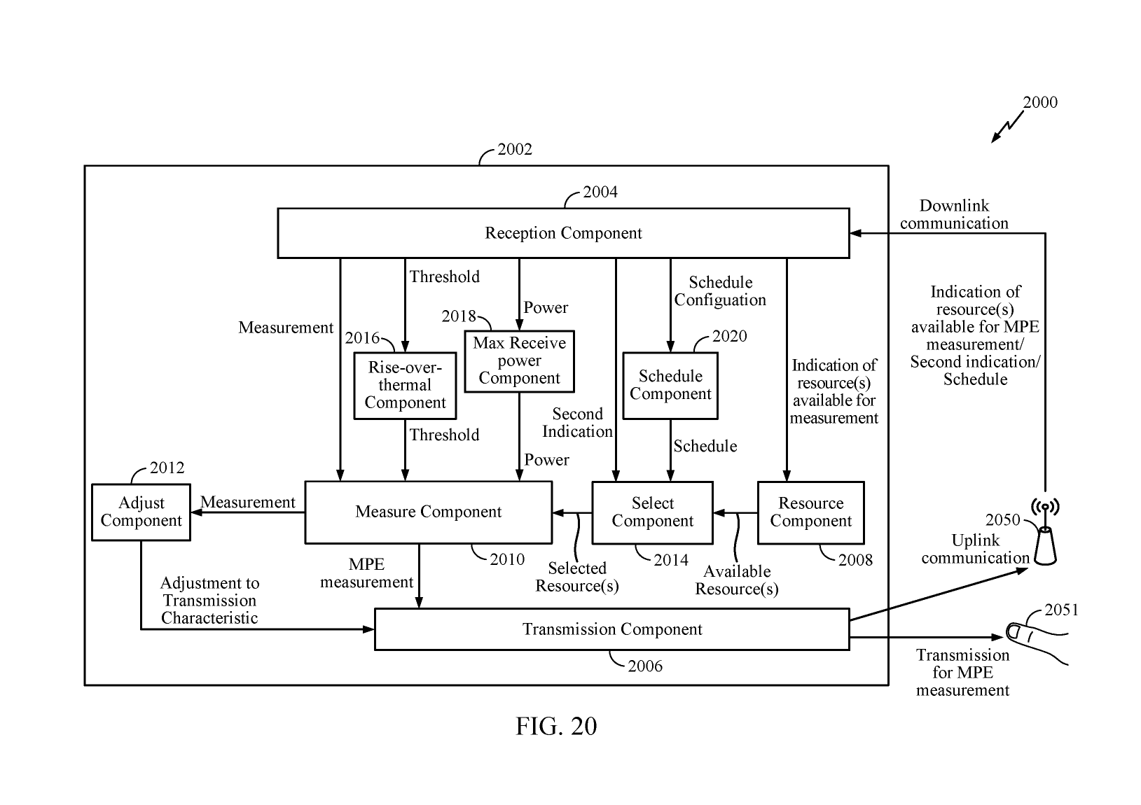

FIG. 20 is a conceptual data flow diagram 2000 illustrating the data flow between different means/components in an exemplary apparatus 2002. The apparatus may be a UE (e.g., the UE 120, 1404, 1808, 2350) communicating with a base station 2050 (e.g., base station 110, 1402, 1502, the apparatus 2302, 2302′). The apparatus includes a reception component 2004 that receives downlink communication from base station 2050 and that receives a signal based on a MPE transmission as part of an exposure measurement. The apparatus includes a transmission component 2006 that transmits uplink communication to base station 2050 and that transmits a transmission as part of an MPE measurement to detect an exposure condition regarding a portion of a person's body 2051 being exposed to RF energy from the transmission component 2006. The apparatus includes a resource component 2008 configure to receive an indication of a cell specific resource available for MPE measurement. The apparatus includes a measure component 2010 configured to perform a measurement based on the cell specific resource, e.g., by transmitting a transmission via the transmission component 2006 and using reception component 2004 to measure and detect when a portion of a person's body 2051 is in the direction of a transmitting antenna element. The apparatus includes an adjust component 2012 that determines whether to adjust a transmission characteristic, e.g., of transmission component 2006, based on whether the measurement meets a threshold. The adjust component 2006 may adjust any of a transmission power, a transmission direction, an antenna sub-array selection, or an antenna module selection based on the result of the MPE measurement. When the threshold is met, the adjust component 2006 may adjust the transmission characteristic and may send an indication to the base station 2050 regarding the adjustment.

The apparatus may include a rise-over-thermal component 2016 that receives an indication of a rise-over-thermal threshold and that provides the threshold to the measure component 2010 for use in performing the MPE measurement. The apparatus may include a maximum receive power component 2018 configured to receive a maximum receiving power at which a transmission for the measurement may be received at a base station. The maximum receive power component 2018 may provide the maximum receiving power indication to the measure component 2010 for use in performing the MPE measurement.

The apparatus may comprise a select component 2014 configured to select a resource, from the resources available for MPE measurement, for performing the MPE measurement. For example, the select component 2014 may receive the indication regarding the resources available for MPE measurement from resource component 2008. The select component 2014 may autonomously select a resource, e.g., which may be based on measurements made by the UE.

Alternately, the select component may receive additional indications from the base station 2050 that manage or otherwise control the use of the resources available for MPE measurement. The apparatus may include components that receive additional indications from base station 2050 that control the use of resources for MPE measurement. For example, the select component may receive a second indication indicating that the apparatus may use a cell specific resource for MPE measurement, or the select component may receive a second indication indicating that the apparatus may not use a cell specific resource for MPE measurement. The apparatus may include a schedule component 2020 that receives a schedule configuration for the UE. The select component 2014 may use the schedule configuration to select an unscheduled resource for performing the MPE measurement. The schedule component may receive a scheduled period for the MPE measurement and may provide the scheduled period to the select component 2014.

The apparatus may include additional components that perform each of the blocks of the algorithm in the aforementioned flowchart of FIG. 19. As such, each block in the aforementioned flowcharts of FIG. 19 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

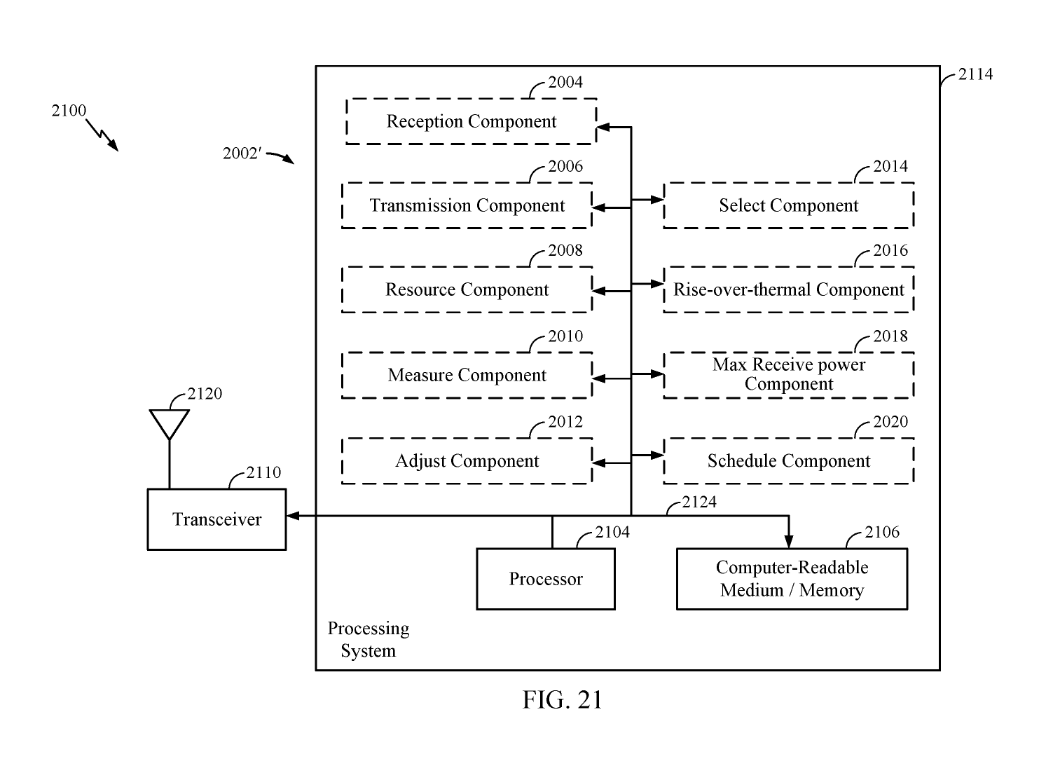

FIG. 21 is a diagram 2100 illustrating an example of a hardware implementation for an apparatus 2002′ employing a processing system 2114. The processing system 2114 may be implemented with a bus architecture, represented generally by the bus 2124. The bus 2124 may include any number of interconnecting buses and bridges depending on the specific application of the processing system 2114 and the overall design constraints. The bus 2124 links together various circuits including one or more processors and/or hardware components, represented by the processor 2104, the components 2004, 2006, 2008, 2010, 2012, 2014, 2016, 2018, 2020, and the computer-readable medium/memory 2106. The bus 2124 may also link various other circuits such as timing sources, peripherals, voltage regulators, and power management circuits, which are well known in the art, and therefore, will not be described any further.

The processing system 2114 may be coupled to a transceiver 2110. The transceiver 2110 is coupled to one or more antennas 2120. The transceiver 2110 provides a means for communicating with various other apparatus over a transmission medium. The transceiver 2110 receives a signal from the one or more antennas 2120, extracts information from the received signal, and provides the extracted information to the processing system 2114, specifically the reception component 2004. In addition, the transceiver 2110 receives information from the processing system 2114, specifically the transmission component 2006, and based on the received information, generates a signal to be applied to the one or more antennas 2120. The processing system 2114 includes a processor 2104 coupled to a computer-readable medium/memory 2106. The processor 2104 is responsible for general processing, including the execution of software stored on the computer-readable medium/memory 2106. The software, when executed by the processor 2104, causes the processing system 2114 to perform the various functions described supra for any particular apparatus. The computer-readable medium/memory 2106 may also be used for storing data that is manipulated by the processor 2104 when executing software. The processing system 2114 further includes at least one of the components 2004, 2006, 2008, 2010, 2012, 2014, 2016, 2018, 2020. The components may be software components running in the processor 2104, resident/stored in the computer readable medium/memory 2106, one or more hardware components coupled to the processor 2104, or some combination thereof. The processing system 2114 may be a component of the UE 120 and may include the memory 282 and/or at least one of the TX Data processor 270, the RX Data processor 288, and the controller/processor 280.

In one configuration, the apparatus 2002/2002′ for wireless communication includes means for receiving an indication of a comprising a cell specific resource available for MPE measurement, means for performing a measurement based on the cell specific resource, means for determining whether to adjust a transmission characteristic of the user equipment based on whether the measurement meets a threshold, means for receiving an indication from a network that the cell-specific resource may be used for the measurement, means for receiving an indication that the cell specific resource may not be used for the measurement, means for receiving an indication regarding use of an uplink resource for the measurement, means for receiving a rise-over-thermal threshold for the measurement from a base station, means for receiving a maximum receiving power at which an MPE use may be received at a base station, means for receiving a scheduled period for the measurement from a base station, means for adjusting a transmission characteristic of the user equipment when the measurement meets the threshold, and means for indicating an adjustment of the transmission characteristic to a base station. The aforementioned means may be one or more of the aforementioned components of the apparatus 2002 and/or the processing system 2114 of the apparatus 2002′ configured to perform the functions recited by the aforementioned means. As described supra, the processing system 2114 may include the TX Data Processor 288, the RX Data Processor 270, and the controller/processor 280. As such, in one configuration, the aforementioned means may be the TX Data Processor 288, the RX Data Processor 270, and the controller/processor 280 configured to perform the functions recited by the aforementioned means.

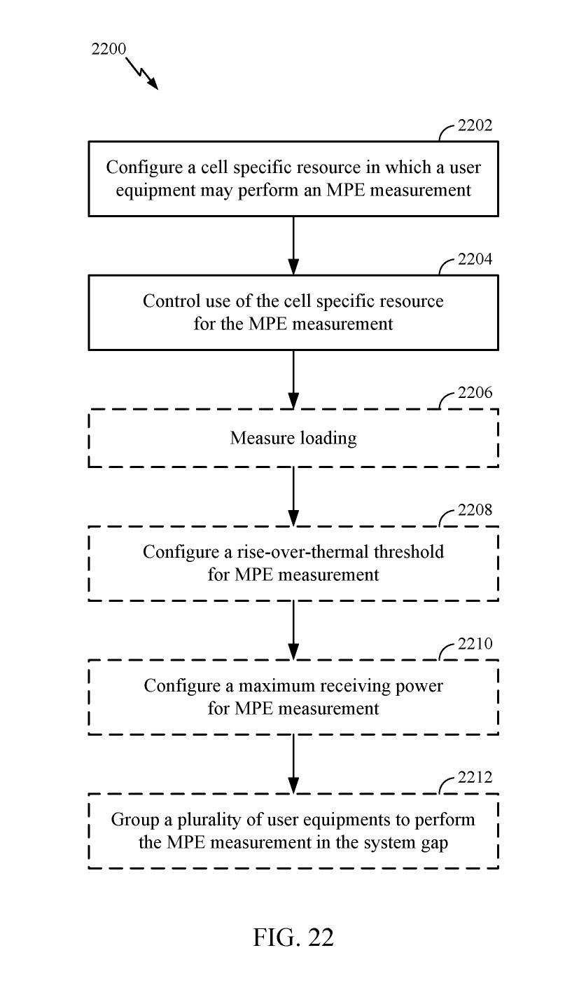

FIG. 22 is a flowchart 2200 of a method of wireless communication. The method may be performed by a base station (e.g., base station 110, 1402, 1502, 2050, the apparatus 2302, 2302′). At 2202, the base station configures a cell specific resource in which a user equipment may perform an MPE measurement, e.g., an MPE measurement as described in connection with FIGS. 15-18. The cell specific resource may comprise at least one of a RACH resource, a beam failure recovery resource, and/or a scheduling request resource. In another example, the cell specific resource may comprise a downlink resource.

At 2204, the base station controls use of the cell specific resource for the MPE measurement. For example, the base station may transmit an indication that an uplink resource may be used for the MPE measurement. Thus, the UE may wait to receive an indication that the resource may be used for MPE measurement before performing measurements based on the resource. As another example, the base station may transmit an indication that an uplink resource may not be used for the MPE measurement. Thus, the UE may choose whether or not to use the resource for MPE measurement, unless the base station indicates that the resource may not be used. The base station may set a parameter that governs when an uplink resource may be used for the MPE measurement. The base station may transmit an indication regarding use of an uplink resource for the MPE measurement, wherein the indication comprises a parameter in at least one of a MIB, SIB, other system information, a MAC CE, DCI, or RRC message. The indication may throttle or otherwise place a limit on a UE's use of the uplink resource for the MPE measurement. The base station may transmit a scheduled period for the MPE measurement to a user equipment. The scheduled period for the MPE measurement may be based on a pending uplink data transmission for the user equipment.

The cell specific resource may comprise a RACH resource. In this example, the base station may measure loading during the cell specific resource at 2206, e.g., the RACH loading. Then, the base station may transmit an indication that identifies limits on the use of the RACH resource for the MPE measurement based on the RACH loading measured at 2206.

The base station may configure a rise-over-thermal threshold for the MPE measurement to the UE at 2208 that the base station may indicate to the UE, e.g., in a transmission. The base station may configure, at 2210, a maximum receiving power at which a transmission from the UE for MPE measurement may be received at the base station. The base station may indicate the maximum receiving power to the UE, e.g., in a transmission.

The base station may group, at 2212, a plurality of UEs to perform the MPE measurement in the system gap. The grouping may be based on the plurality of UEs having disparate pathloss.

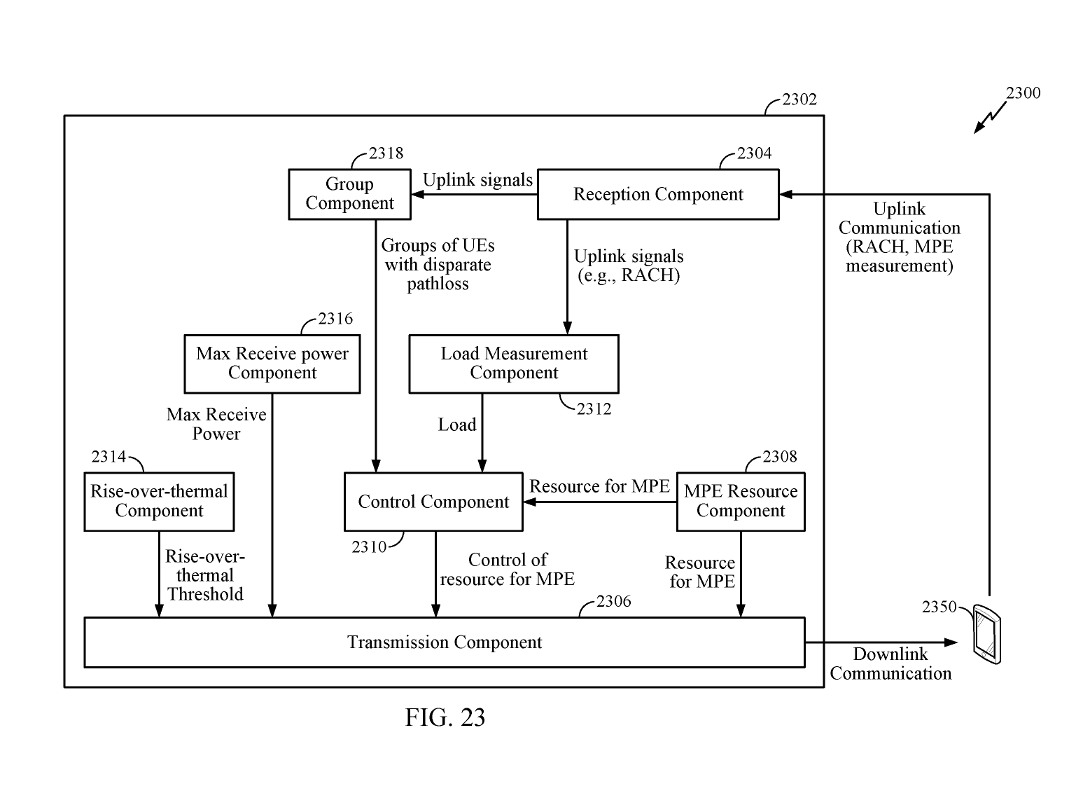

FIG. 23 is a conceptual data flow diagram 2300 illustrating the data flow between different means/components in an exemplary apparatus 2302. The apparatus may be a base station (e.g., base station 110, 1402, 1502) communication with a UE (e.g., the UE 120, 1404, 1808, 2350, the apparatus 2002, 2002′). The apparatus includes a reception component 2304 that receives uplink communication from UE 2350, including RACH and transmissions made by the UE for MPE measurement. The apparatus includes a transmission component 2306 that transmits downlink communication to the UE 2350. The apparatus may comprise an MPE resource component 2308 that configures a cell specific resource in which a user equipment may perform a MPE measurement. The apparatus may also include a control component 2310 configured to control use of the cell specific resource for the MPE measurement, e.g., as described in connection with FIGS. 19 and 22.

The apparatus may include a load measurement component 2312 configured to measure a load on a cell specific resource for MPE measurement. For example, the load measurement component 2312 may measure a RACH loading, and the control component 2310 may limit, or otherwise control, use of the cell specific resource for MPE measurement based on the measured load for the resource.

The apparatus may include a rise-over-thermal component 2314 that may transmit a rise-over-thermal threshold for the MPE measurement to the UE 2350 via transmission component 2306. The apparatus may include a max receive power component 2316 that transmits a maximum receiving power to UE 2350 via the transmission component 2306, the max receiving power being a maximum at which a transmission from the UE 2350 for MPE measurement may be received at the base station.

The apparatus may include group component 2318 configured to group a plurality of UEs to perform the MPE measurement. The grouping may be based on the plurality of user equipment having disparate pathloss and may be provided to the control component 2310 for control/management of the resource for MPE measurement.

The apparatus may include additional components that perform each of the blocks of the algorithm in the aforementioned flowchart of FIG. 22. As such, each block in the aforementioned flowchart of FIG. 22 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

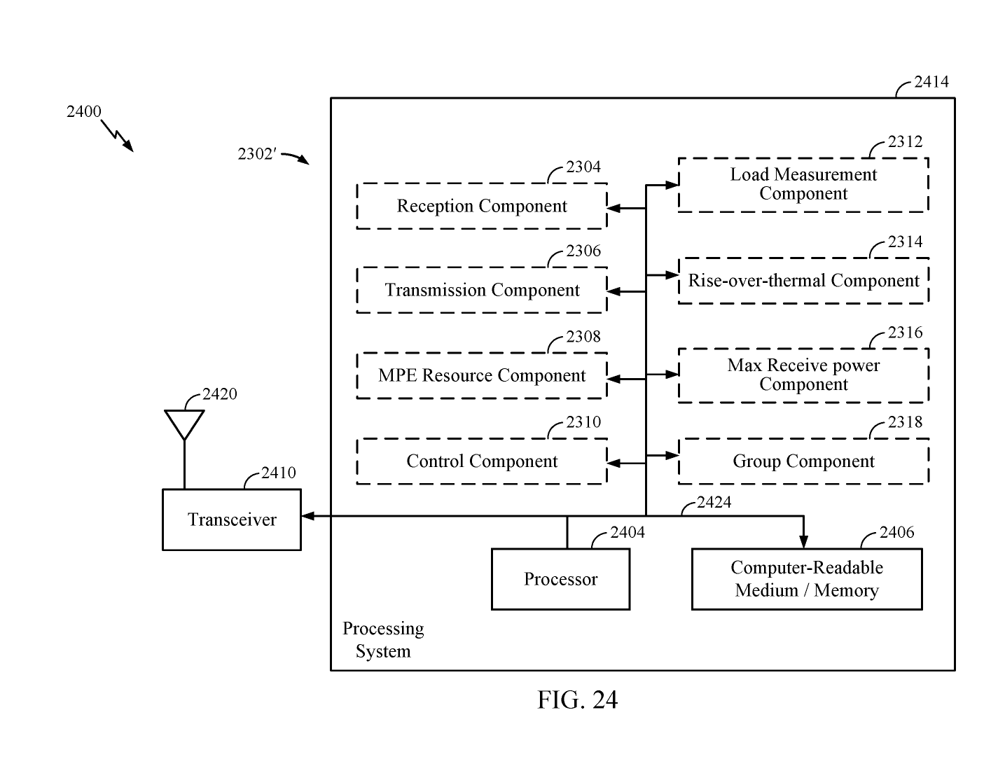

FIG. 24 is a diagram 2400 illustrating an example of a hardware implementation for an apparatus 2302′ employing a processing system 2414. The processing system 2414 may be implemented with a bus architecture, represented generally by the bus 2424. The bus 2424 may include any number of interconnecting buses and bridges depending on the specific application of the processing system 2414 and the overall design constraints. The bus 2424 links together various circuits including one or more processors and/or hardware components, represented by the processor 2404, the components 2304, 2306, 2308, 2310, 2312, 2314, 2316, 2318, and the computer-readable medium/memory 2406. The bus 2424 may also link various other circuits such as timing sources, peripherals, voltage regulators, and power management circuits, which are well known in the art, and therefore, will not be described any further.

The processing system 2414 may be coupled to a transceiver 2410. The transceiver 2410 is coupled to one or more antennas 2420. The transceiver 2410 provides a means for communicating with various other apparatus over a transmission medium. The transceiver 2410 receives a signal from the one or more antennas 2420, extracts information from the received signal, and provides the extracted information to the processing system 2414, specifically the reception component 2304. In addition, the transceiver 2410 receives information from the processing system 2414, specifically the transmission component 2306, and based on the received information, generates a signal to be applied to the one or more antennas 2420. The processing system 2414 includes a processor 2404 coupled to a computer-readable medium/memory 2406. The processor 2404 is responsible for general processing, including the execution of software stored on the computer-readable medium/memory 2406. The software, when executed by the processor 2404, causes the processing system 2414 to perform the various functions described supra for any particular apparatus. The computer-readable medium/memory 2406 may also be used for storing data that is manipulated by the processor 2404 when executing software. The processing system 2414 further includes at least one of the components 2304, 2306, 2308, 2310, 2312, 2314, 2316, 2318. The components may be software components running in the processor 2404, resident/stored in the computer readable medium/memory 2406, one or more hardware components coupled to the processor 2404, or some combination thereof. The processing system 2414 may be a component of the base station 110 and may include the memory 232 and/or at least one of the TX Data processor 210, the RX Data processor 242, and the controller/processor 230

In one configuration, the apparatus 2302/2302′ for wireless communication includes means for configuring a cell specific resource in which a user equipment may perform an MPE measurement, means for controlling use of the cell specific resource for the MPE measurement, means for transmitting an indication that an uplink resource may be used for the MPE measurement, means for transmitting an indication that an uplink resource may not be used for the MPE measurement, means for setting a parameter that governs when an uplink resource may be used for the MPE measurement, means for transmitting an indication regarding use of an uplink resource for the MPE measurement, means for measuring a RACH loading, means for transmitting a rise-over-thermal threshold for the MPE measurement, means for transmitting a maximum receiving power at which an MPE use may be received at the base station, means for transmitting a scheduled period for the MPE measurement to a user equipment, and means for grouping a plurality of UEs to perform the MPE measurement in the system gap. The aforementioned means may be one or more of the aforementioned components of the apparatus 2302 and/or the processing system 2414 of the apparatus 2302′ configured to perform the functions recited by the aforementioned means. As described supra, the processing system 2414 may include the TX Data Processor 210, the RX Data Processor 242, and the controller/processor 230. As such, in one configuration, the aforementioned means may be the TX Data Processor 210, the RX Data Processor 242, and the controller/processor 230 configured to perform the functions recited by the aforementioned means.

### Example Calibration Gap Measurement

In certain aspects, the UE may obtain a period for a calibration gap (e.g., calibration gap period 514 depicted in FIG. 5) to perform a measurement including a PA characterization (e.g., PA characterization at 608 depicted in FIG. 6), a PA characterization using a single-PA element for compressed mode (e.g., the single-element PA characterization with regard to FIGS. 12 and 13), or a performing a maximum permissible radio frequency (RF) exposure measurement (e.g., the MPE measurement described with respect to FIG. 16).

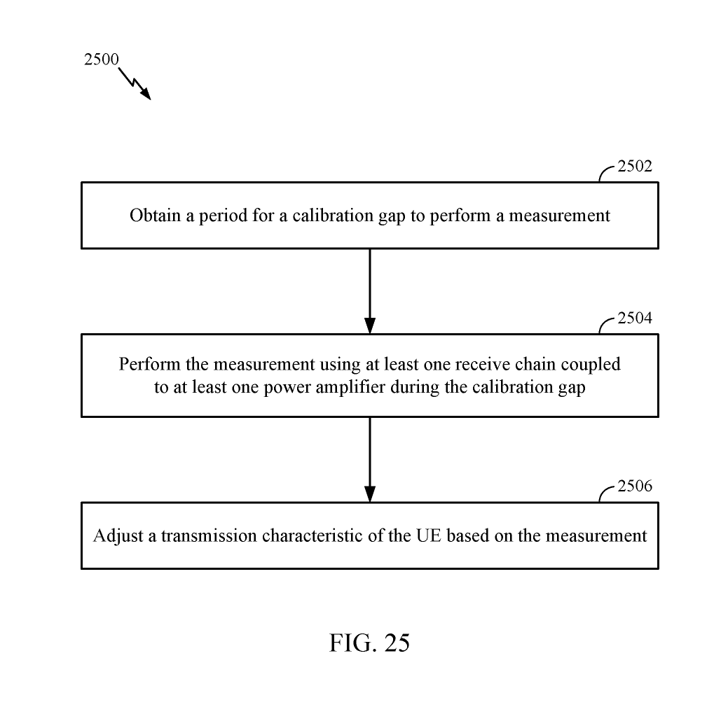

FIG. 25 illustrates example operations 2500 for performing a measurement during a calibration gap period, in accordance with certain aspects of the present disclosure. The operations 2500 may be performed by a wireless communications device, such as a user equipment (e.g., UE 120 of FIG. 1).

The operations 2500 may begin at block 2502, by the UE obtaining a period for a calibration gap (e.g., calibration gap period 514 depicted in FIG. 5) to perform a measurement. At block 2504, the UE may perform the measurement using at least one receive chain (e.g., receive chain 420 of FIG. 4) coupled to at least one power amplifier (e.g., power amplifier 316 of FIG. 3) during the calibration gap. At block 2506, the UE may adjust a transmission characteristic of the UE based on the measurement.

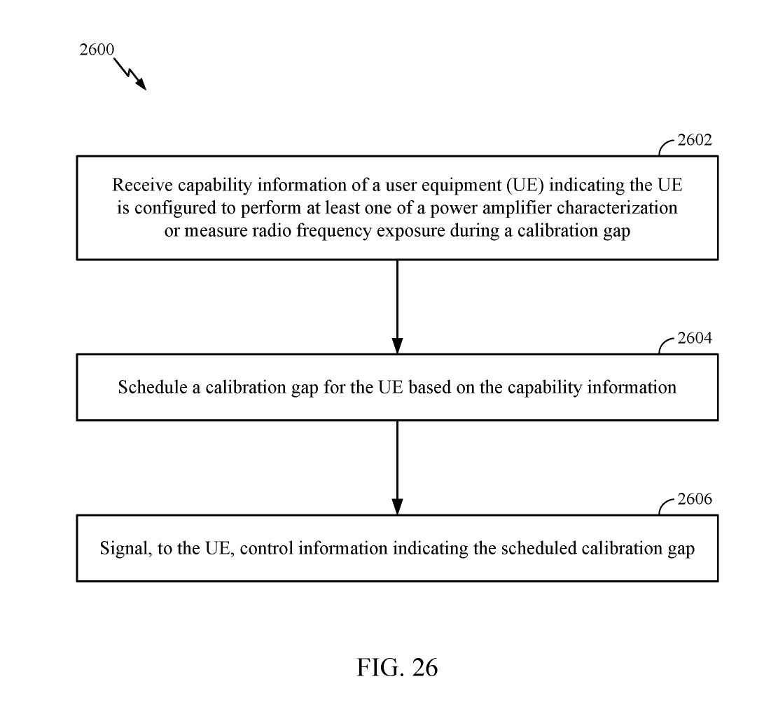

FIG. 26 illustrates example operations 2600 for scheduling a calibration gap period for a measurement, in accordance with certain aspects of the present disclosure. The operations 2600 may be performed by a wireless communications device, such as a base station (e.g., BS 110 of FIG. 1).

The operations 2600 may begin at block 2602, by the BS receiving capability information of a UE (e.g., UE 120 of FIG. 1) indicating the UE is configured to perform at least one of a power amplifier characterization or measure radio frequency exposure during a calibration gap. At block 2604, the BS may schedule a calibration gap for the UE based on the capability information. At block 2606, the BS may signal, to the UE, control information indicating the schedule calibration gap.

In certain aspects, performing the measurement at block 2504 may include performing a power amplifier characterization of the at least one power amplifier, such as the power amplifier characterization described herein with respect to operations 600 at block 608 of FIG. 6. In other aspects, performing the measurement at block 2504 may include operating the at least one power amplifier at a power level where a power amplifier distortion of the at least one power amplifier is dominated by signal compression (such as the compressed mode as described herein with respect to FIGS. 12 and 13).

In certain aspects, performing the power amplifier characterization may include amplifying a modulated signal using the at least one power amplifier, the at least one power amplifier being associated with one or more transmit chains of a first antenna layer and coupling an output of the at least one power amplifier to the at least one receive chain associated with a second antenna layer. The coupling of the output of the PA to the receive chain may include coupling wirelessly or coupling using a wired interface.

In certain aspects, the operations 2500 may include determining, by the UE, if a transmit power used by the UE for transmitting signals has changed by at least a threshold over a time period, and performing the measurement may include performing the measurement after determining that the transmit power has changed by at least the threshold. In other aspects, the operations 2500 may include determining, by the UE, if a modulation bandwidth used by the UE for transmitting signals has increased over a time period, and performing the measurement may include performing the measurement after determining that the transmit power has changed by at least the threshold.

In certain aspects, adjusting the transmission characteristic of the UE may include performing digital predistortion of one or more signals input into the at least one power amplifier based on the power amplifier characterization.

In certain aspects, performing the measurement at block 2504 may include performing a maximum permissible radio frequency (RF) exposure measurement. The transmission characteristic adjusted at 2506 may include a transmission power, a transmission direction, an antenna array selection, or an antenna module selection.

In certain aspects, obtaining the period for the calibration gap at block 2502 may include receiving signaling, from a base station, indicating a scheduled period for the calibration gap. For example, the signaling may be via a master information block (MIB), a system information block (SIB), a medium access control (MAC) control element, a downlink control information (DCI) message, and/or a radio resource control (RRC) message.

In certain aspects, the at least one receive chain may be configured for transmission or reception on an alternate polarization outside of the calibration gap.

In certain aspects, the control information signaled at block 2606 may include an indication that the UE is to perform a power amplifier characterization during the scheduled calibration gap. In other aspects, the control information signaled at block 2606 may include an indication that UE is to perform radio frequency exposure measurement during the scheduled calibration gap. In aspects, the control information may include an indication that an uplink resource is to be used during the calibration gap. The control information may include a maximum receive power of a transmission to be received at the BS from the UE during the calibration gap. The control information may be included in at least one of a master information block (MIB), a system information block (SIB), a medium access control (MAC) control element, a downlink control information (DCI) message, or a radio resource control (RRC) message.

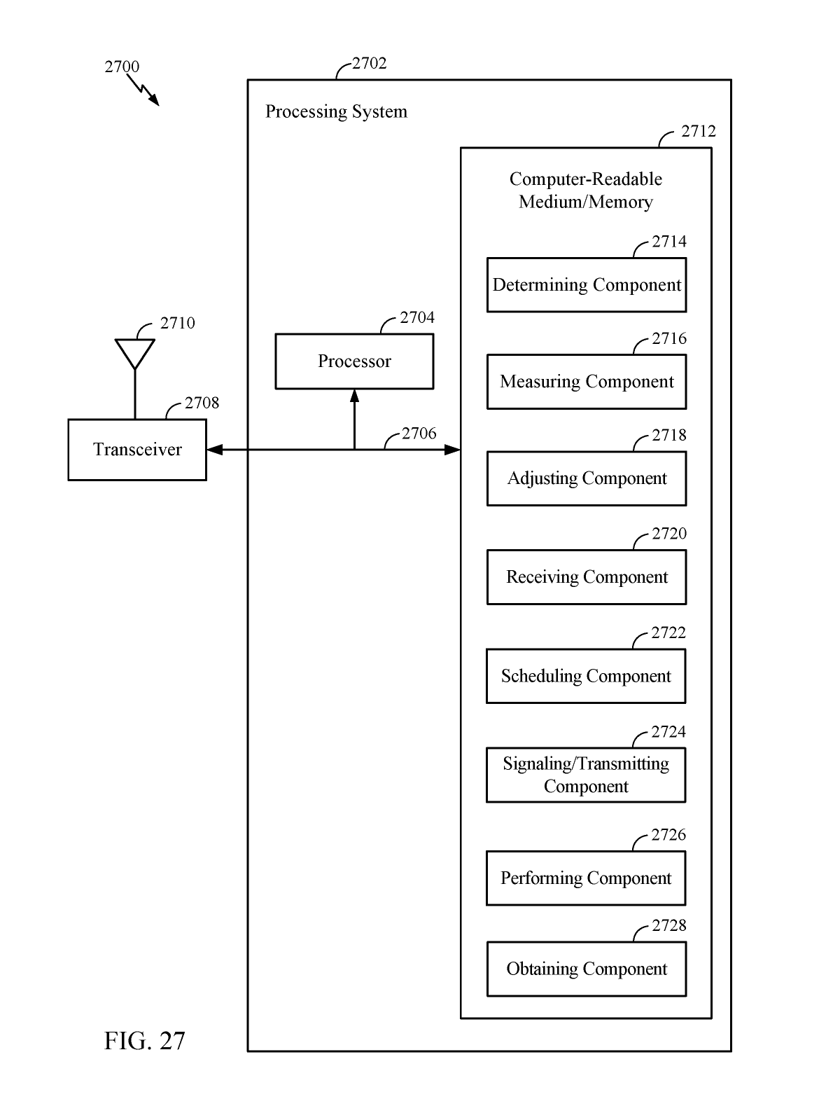

FIG. 27 illustrates a communications device 2700 (e.g., BS 110 or UE 120) that may include various components (e.g., corresponding to means-plus-function components) configured to perform operations for the techniques disclosed herein, such as the operations illustrated in FIGS. 6-11, 19, 22, 25, and 26. The communications device 2700 includes a processing system 2702 coupled to a transceiver 2708. The transceiver 2708 is configured to transmit and receive signals for the communications device 2700 via an antenna 2710, such as the various signal described herein. The processing system 2702 may be configured to perform processing functions for the communications device 2700, including processing signals received and/or to be transmitted by the communications device 2700.

The processing system 2702 includes a processor 2704 coupled to a computer-readable medium/memory 2712 via a bus 2706. In certain aspects, the computer-readable medium/memory 2712 is configured to store instructions that when executed by processor 2704, cause the processor 2704 to perform the operations illustrated in FIGS. 6-11, 19, 22, 25, and 26, or other operations for performing the various techniques discussed herein.

In certain aspects, the processing system 2702 may further include a determining component 2714 for performing the operations illustrated in FIGS. 6-11, 19, 22, 25, and 26, or other aspects of the operations described herein. Additionally, the processing system 2702 may include a measuring component 2716 for performing the operations illustrated in FIGS. 6-11, 19, 22, 25, and 26, or other aspects of the operations described herein. Additionally, the processing system 2702 may include an adjusting component 2718 for performing the operations illustrated in FIGS. 6-11, 19, 22, 25, and 26, or other aspects of the operations described herein. Additionally, the processing system 2702 may include a receiving component 2720 for performing the operations illustrated in FIGS. 6-11, 19, 22, 25, and 26, or other aspects of the operations described herein. Additionally, the processing system 2702 may include a scheduling component 2722 for performing the operations illustrated in FIGS. 6-11, 19, 22, 25, and 26, or other aspects of the operations described herein. Additionally, the processing system 2702 may include a signaling/transmitting component 2724 for performing the operations illustrated in FIGS. 6-11, 19, 22, 25, and 26, or other aspects of the operations described herein. Additionally, the processing system 2702 may include a performing component 2726 for performing the operations illustrated in FIGS. 6-11, 19, 22, 25, and 26, or other aspects of the operations described herein. Additionally, the processing system 2702 may include an obtaining component 2728 for performing the operations illustrated in FIGS. 6-11, 19, 22, 25, and 26, or other aspects of the operations described herein.

The determining component 2714, measuring component 2716, adjusting component 2718, receiving component 2720, scheduling component 2722, signaling/transmitting component 2724, performing component 2726, and/or obtaining component 2728 may be coupled to the processor 2704 via bus 2706. In certain aspects, the determining component 2714, measuring component 2716, adjusting component 2718, receiving component 2720, scheduling component 2722, signaling/transmitting component 2724, performing component 2726, and/or obtaining component 2728 may be hardware circuits. In certain aspects, the determining component 2714, measuring component 2716, adjusting component 2718, receiving component 2720, scheduling component 2722, signaling/transmitting component 2724, performing component 2726, and/or obtaining component 2728 may be software components that are executed and run on processor 2704.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components.

For example, means for determining, means for measuring, means for adjusting, means for receiving, means for scheduling, means for signaling, means for transmitting, means for performing, and/or means for obtaining may comprise one or more processors or antennas at the BS 110 or UE 120, such as the transmit processor 220, controller/processor 240, receive processor 238, or antennas 224 at the BS 110 and/or the transmit processor 264, controller/processor 280, receive processor 258, or antennas 252 at the UE 120.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of wireless communication by a user equipment (UE), comprising:
obtaining a period for a calibration gap to perform a measurement;
performing the measurement using at least one receive chain coupled to at least one power amplifier during the calibration gap; and
adjusting a transmission characteristic of the UE based on the measurement.

2. The method of claim 1, wherein performing the measurement comprises performing a power amplifier characterization of the at least one power amplifier.

3. The method of claim 2, wherein performing the measurement comprises operating the at least one power amplifier at a power level where a power amplifier distortion of the at least one power amplifier is dominated by signal compression.

4. The method of claim 2, wherein performing the power amplifier characterization comprises:
amplifying a modulated signal using the at least one power amplifier, the at least one power amplifier being associated with one or more transmit chains of a first antenna layer; and
coupling an output of the at least one power amplifier to the at least one receive chain associated with a second antenna layer.

5. The method of claim 4, wherein coupling comprises coupling wirelessly.

6. The method of claim 4, wherein coupling comprises coupling using a wired interface.

7. The method of claim 2, further comprising:
determining, by the UE, if a transmit power used by the UE for transmitting signals has changed by at least a threshold over a time period;
wherein performing the measurement comprises performing the measurement after determining that the transmit power has changed by at least the threshold.

8. The method of claim 2, further comprising:
determining, by the UE, if a modulation bandwidth used by the UE for transmitting signals has increased over a time period;
wherein performing the measurement comprises performing the measurement after determining that the transmit power has changed by at least the threshold.

9. The method of claim 2, wherein adjusting the transmission characteristic of the UE comprises performing digital predistortion of one or more signals input into the at least one power amplifier based on the power amplifier characterization.

10. The method of claim 1, wherein performing the measurement comprises performing a maximum permissible radio frequency (RF) exposure measurement.

11. The method of claim 10, wherein the transmission characteristic is a transmission power, a transmission direction, an antenna array selection, or an antenna module selection.

12. The method of claim 1, wherein obtaining the period for the calibration gap comprises receiving signaling, from a base station, indicating a scheduled period for the calibration gap.

13. The method of claim 1, wherein the at least one receive chain is configured for transmission or reception on an alternate polarization outside of the calibration gap.

14. A method of wireless communication by a base station (BS), comprising:
receiving capability information of a user equipment (UE) indicating the UE is configured to perform at least one of a power amplifier characterization or measure radio frequency exposure during a calibration gap;
scheduling a calibration gap for the UE based on the capability information; and
signaling, to the UE, control information indicating the scheduled calibration gap.

15. The method of claim 14, wherein the control information includes an indication that the UE is to perform a power amplifier characterization during the scheduled calibration gap.

16. The method of claim 14, wherein the control information includes an indication that UE is to perform radio frequency exposure measurement during the scheduled calibration gap.

17. The method of claim 14, wherein the control information includes an indication that an uplink resource is to be used during the calibration gap.

18. The method of claim 14, wherein the control information includes a maximum receive power of a transmission to be received at the BS from the UE during the calibration gap.

19. The method of claim 14, wherein the control information is included in at least one of a master information block (MIB), a system information block (SIB), a medium access control (MAC) control element, a downlink control information (DCI) message, or a radio resource control (RRC) message.

20. An apparatus for wireless communication, comprising:
a processing system configured to:
obtain a period for a calibration gap to perform a measurement, and
perform the measurement using at least one receive chain coupled to at least one power amplifier during the calibration gap; and
a transmitter configured to adjust a transmission characteristic of the UE based on the measurement.

21. An apparatus for wireless communication, comprising:
a receiver configured to receive capability information of a user equipment (UE) indicating the UE is configured to perform at least one of a power amplifier characterization or measure radio frequency exposure during a calibration gap;
a processing system configured to schedule a calibration gap for the UE based on the capability information; and
a transmitter configured to transmit, to the UE, control information indicating the scheduled calibration gap.
